(19) United States
(12) Patent Application Publication
(10) Pub. No.: US 2026/0059640 A1
(43) Pub. Date: Feb. 26, 2026

(54) DROPLET STABILITY ENHANCEMENT

(71) Applicant: KLA Corporation, Milpitas, CA (US)

(72) Inventors: Anton Tkachev, San Jose, CA (US); Chong Liu, San Francisco, CA (US); Aron Welk, Tracy, CA (US)

(21) Appl. No.: 19/282,325

(22) Filed: Jul. 28, 2025

Related U.S. Application Data
(60) Provisional application No. 63/686,196, filed on Aug. 23, 2024.
(60) Provisional application No. 63/686,172, filed on Aug. 23, 2024.

(51) Int. Cl. H05G 2/00

(52) U.S. Cl. CPC H05G 2/0023; H05G 2/0027; H05G 2/003

(57) ABSTRACT

A droplet generator may form a stable chain of droplets. The droplet generator may enhance the stability of the chain of droplets using a nozzle, a multi-stage skimmer, and/or gas-distribution ring. The nozzle may include a nozzle orifice and filter which may control a target-material flow forming a jet and subsequently coalescing into droplets. The skimmer may include apertures and/or capillaries which are arranged axially along the path of the chain of droplets to skim off a flow of ambient gas. The gas-distribution ring may include a set of holes for even gas distribution, improving the flow of ambient gas within an intermediate chamber. The droplet generator may also include gas, electrical, pressure-sensor, and/or temperature-sensor interfaces. The droplet generator may also include clamps to connect the intermediate chamber with the nozzle and skimmer.

### CROSS-REFERENCE

The present application claims the benefit under 35 U.S.C. § 119 of U.S. Provisional application 63/686,196, filed on Aug. 23, 2024, titled “Droplet Stability Enhancement by Improving Droplet Skimmer Design”, and of U.S. Provisional application 63/686,172, filed on Aug. 23, 2024, titled “Droplet Stability Enhancement by Improving Intermediate Transition Chamber Design”, which are incorporated herein by reference in the entirety.

### TECHNICAL FIELD

The present disclosure generally relates to optical systems and, more particularly, to optical systems producing light using plasma.

### BACKGROUND

Plasma-based light sources, such as laser-produced plasma (LPP) sources and laser-discharge produced plasma (LDP or laser-initiated DPP) can generate soft X-ray, extreme ultraviolet (EUV), and/or vacuum ultraviolet (VUV) light for applications such as defect inspection, photolithography, or metrology. In these plasma light sources, light having the desired wavelength is emitted by plasma formed from a target material having an appropriate line-emitting or band-emitting element, the target material irradiated by a laser in a vacuum chamber to produce the plasma. One challenging aspect of the laser-produced plasma sources is to generate droplets of the target material with regularity, alignment, and stability. Another challenging aspect of the laser-produced plasma sources is servicing the droplet generator. Therefore, it would be advantageous to provide a device, system, and method that cures the shortcomings described above.

### SUMMARY

A droplet generator is described, in accordance with one or more embodiments of the present disclosure. The droplet generator may include: an intermediate chamber; a nozzle, wherein the nozzle includes a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets; a transmission line, wherein the transmission line is coupled to and configured to control the piezo-vibrator; a support ring, wherein the support ring mechanically supports the intermediate chamber; a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer.

An illumination source is described, in accordance with one or more embodiments of the present disclosure. The illumination source may include: a droplet generator including: an intermediate chamber; a nozzle, wherein the nozzle includes a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets; a transmission line, wherein the transmission line is coupled to and configured to control the piezo-vibrator; a support ring, wherein the support ring mechanically supports the intermediate chamber; a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer; a vacuum chamber, wherein the droplet generator is configured to supply the chain of target-material droplets into the vacuum chamber via the skimmer; and a laser source, wherein the laser source is configured to generate a laser, wherein the laser is configured to irradiate the target material at a plasma site within the vacuum chamber, wherein the laser causes the target-material droplets to produce a plasma, wherein the plasma is configured to emit illumination.

An inspection system is described, in accordance with one or more embodiments of the present disclosure. The inspection system may include: an illumination source including: a droplet generator including: an intermediate chamber; a nozzle, wherein the nozzle includes a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets; a transmission line, wherein the transmission line is coupled to and configured to control the piezo-vibrator; a support ring, wherein the support ring mechanically supports the intermediate chamber; a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer; a vacuum chamber, wherein the droplet generator is configured to supply the chain of target-material droplets into the vacuum chamber via the skimmer; and a laser source, wherein the laser source is configured to generate a laser, wherein the laser is configured to irradiate the target material at a plasma site within the vacuum chamber, wherein the laser causes the target-material droplets to produce a plasma, wherein the plasma is configured to emit illumination.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A illustrates a top isometric view of a droplet generator, in accordance with one or more embodiments of the present disclosure.

FIG. 1B illustrates a bottom isometric view of the droplet generator, in accordance with one or more embodiments of the present disclosure.

FIG. 1C illustrates a section view along an axial length of the droplet generator, in accordance with one or more embodiments of the present disclosure.

FIG. 1D illustrates a partial section view along an axial length of the droplet generator taken from a different circumferential angle, in accordance with one or more embodiments of the present disclosure.

FIG. 1E illustrates a bottom isometric view of a support ring of the droplet generator, in accordance with one or more embodiments of the present disclosure.

FIG. 1F illustrates a section view along an axial length of the support ring, in accordance with one or more embodiments of the present disclosure.

FIG. 1G illustrates a top isometric view of a nozzle of the droplet generator, in accordance with one or more embodiments of the present disclosure.

FIG. 1H illustrates a section view along an axial length of a nozzle of the droplet generator, in accordance with one or more embodiments of the present disclosure.

FIG. 1I-1J illustrate a partial section view along the axial length of the nozzle to more clearly illustrate a nozzle orifice, a nozzle filter, and a piezo-vibrator of the nozzle, in accordance with one or more embodiments of the present disclosure.

FIG. 1K illustrates a top isometric view of a skimmer of the droplet generator, in accordance with one or more embodiments of the present disclosure.

FIG. 1L illustrates a bottom isometric view of a skimmer of the droplet generator, in accordance with one or more embodiments of the present disclosure.

FIG. 1M illustrates a section view along the axial length of the skimmer with multiple stages of skimmer apertures, in accordance with one or more embodiments of the present disclosure.

FIG. 1N illustrates a section view along the axial length of the skimmer in an alternative configuration with the multiple stages of skimmer apertures and a skimmer capillary, in accordance with one or more embodiments of the present disclosure.

FIG. 1O illustrates a simplified schematic of the droplet generator which is generating a chain of target-material droplets, in accordance with one or more embodiments of the present disclosure.

FIG. 1P illustrates a partial section view along the axial length of the nozzle, in accordance with one or more embodiments of the present disclosure.

FIG. 1Q illustrates a partial section view along the axial length of the nozzle with the nozzle body receiving a screw to remove the nozzle orifice and the nozzle filter, in accordance with one or more embodiments of the present disclosure.

FIG. 1R illustrates a top isometric view of the skimmer with a skimmer body including diametrical notches, in accordance with one or more embodiments of the present disclosure.

FIG. 1S illustrates a partial top isometric view of the droplet generator including the skimmer body and a through-beam sensor, in accordance with one or more embodiments of the present disclosure.

FIG. 2 illustrates a simplified schematic of an illumination source with the droplet generator, in accordance with one or more embodiments of the present disclosure.

FIG. 3 illustrates a conceptual view of an inspection system with the illumination source, in accordance with one or more embodiments of the present disclosure.

FIG. 4 illustrates a flow diagram of a method of generating target-material droplets using the droplet generator, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to droplet stability enhancement by improving droplet skimmer design and by improving intermediate transition chamber design. The droplet generator may form a stable chain of droplets. The droplet generator may enhance the stability of the chain of droplets using a nozzle, a multi-stage skimmer, and/or gas-distribution ring. The nozzle may include a nozzle orifice and filter which may control a target-material flow forming a jet and subsequently coalescing into droplets. The skimmer may include apertures and/or capillaries which are arranged axially along the path of the chain of droplets to skim off a flow of ambient gas. The gas-distribution ring may include a set of holes for even gas distribution, improving the flow of ambient gas within an intermediate chamber. The droplet generator may also include gas, electrical, pressure-sensor, and/or temperature-sensor interfaces. The droplet generator may also include clamps to connect the intermediate chamber with the nozzle and skimmer.

U.S. Pat. N. 9,268,031B2, titled “Advanced debris mitigation of EUV light source”; U.S. Pat. No. 9,295,147B2, titled “EUV light source using cryogenic droplet targets in mask inspection”; U.S. Pat. No. 9,348,214B2, titled “Spectral purity filter and light monitor for an EUV reticle inspection system”; U.S. Pat. No. 10,034,362B2, titled “Plasma-based light source”; U.S. Pat. No. 10,101,664B2, titled “Apparatus and methods for optics protection from debris in plasma-based light source”; U.S. Pat. No. 10,880,979B2, titled “Droplet generation for a laser produced plasma light source”; U.S. Pat. No. 11,112,691B2, titled “Inspection system with non-circular pupil”; U.S. Pat. No. 11,259,394B2, titled “Laser produced plasma illuminator with liquid sheet jet target”; U.S. Pat. No. 11,293,880B2, titled “Method and apparatus for beam stabilization and reference correction for EUV inspection”; U.S. Pat. No. 11,317,500B2, titled “Bright and clean x-ray source for x-ray based metrology”; U.S. Pat. No. 11,343,899B2, titled “Droplet generation for a laser produced plasma light source”; U.S. Pat. No. 12,158,576B2, titled “Counterflow gas nozzle for contamination mitigation in extreme ultraviolet inspection systems”; are each incorporated herein by reference in the entirety.

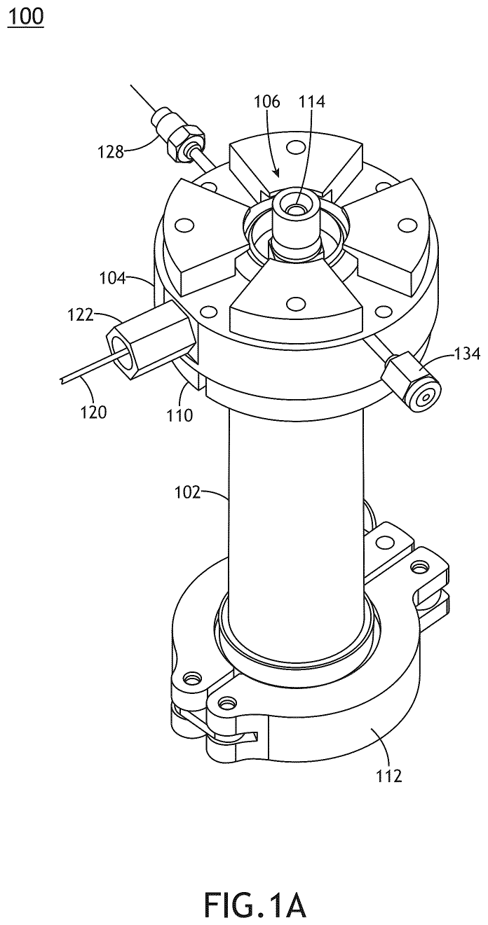

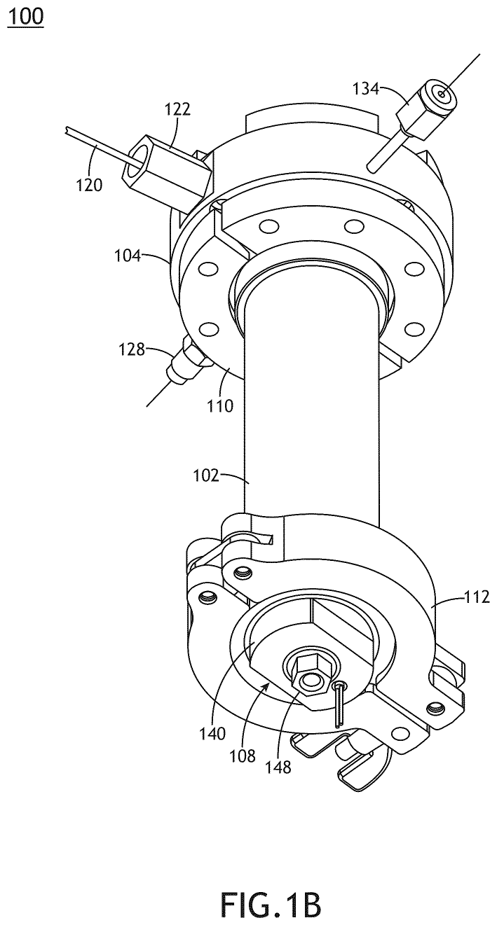

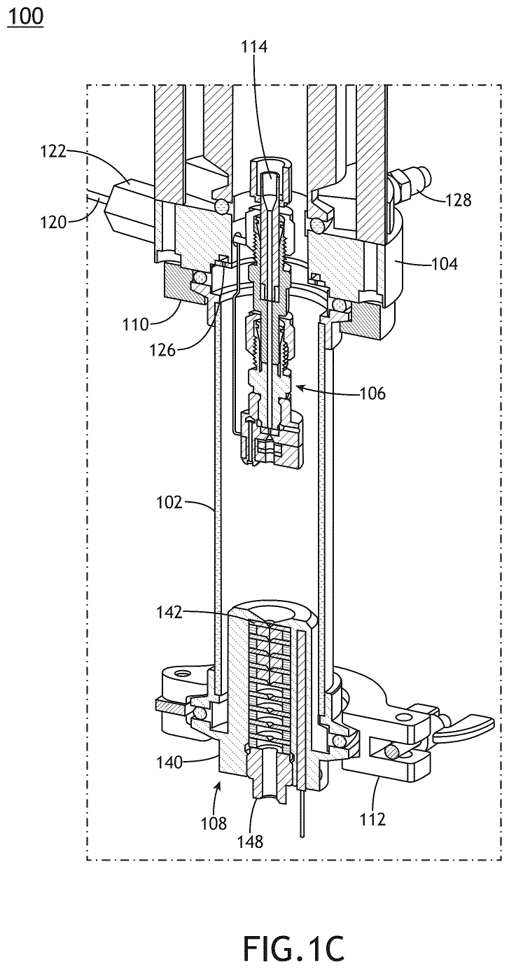

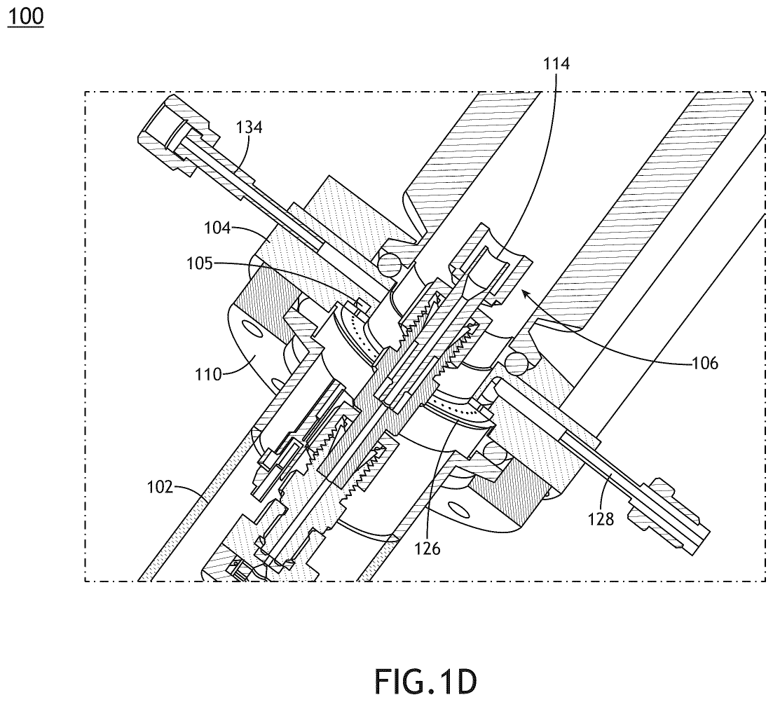

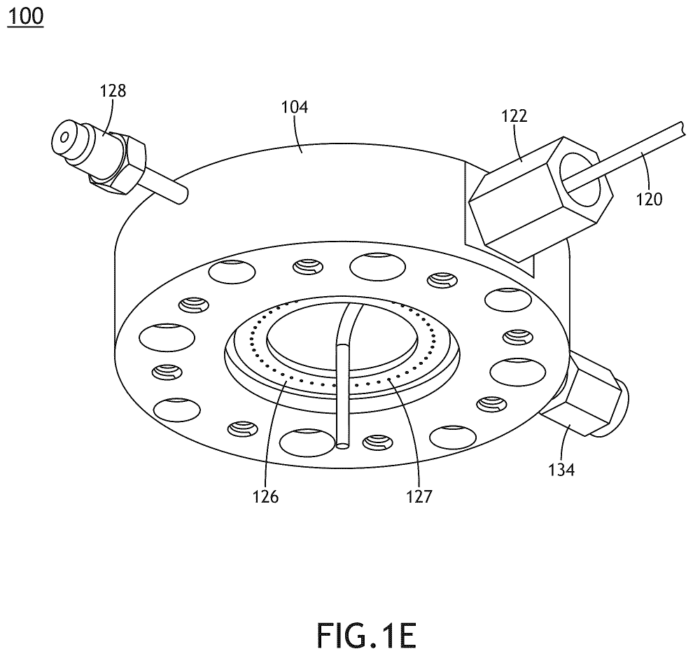

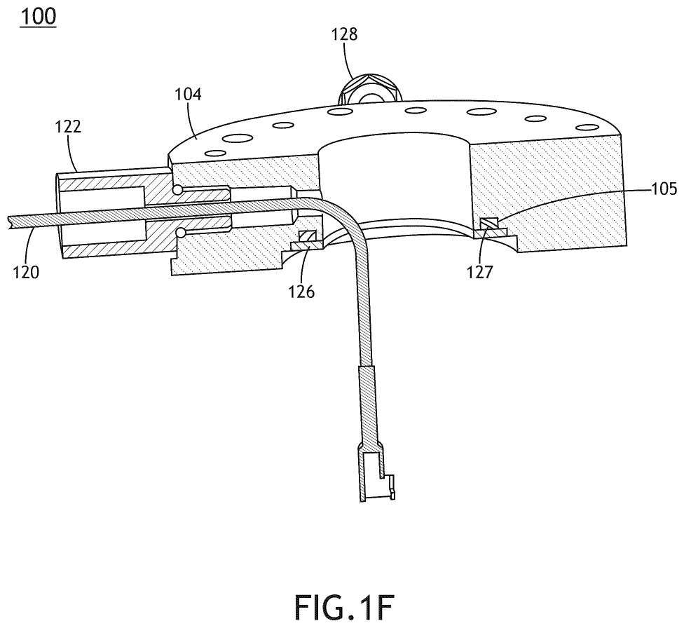

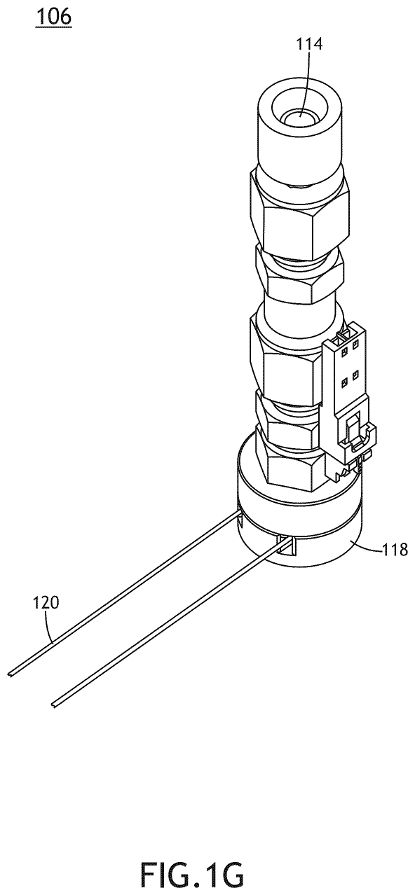

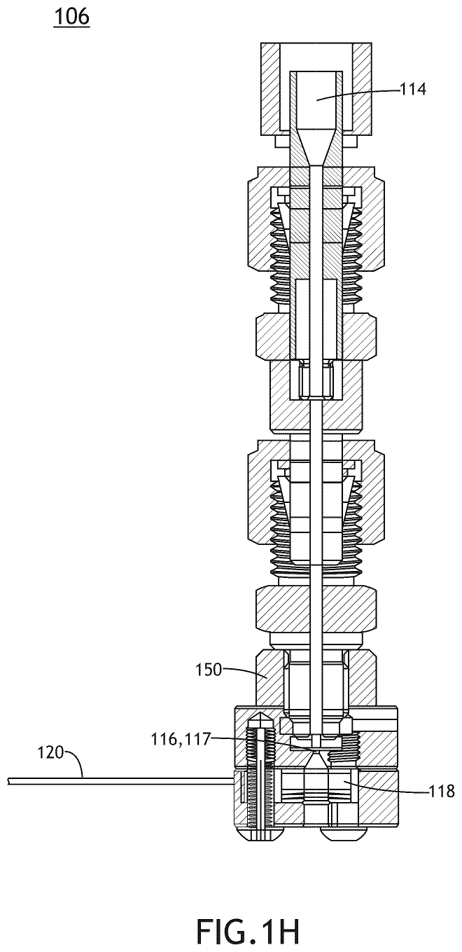

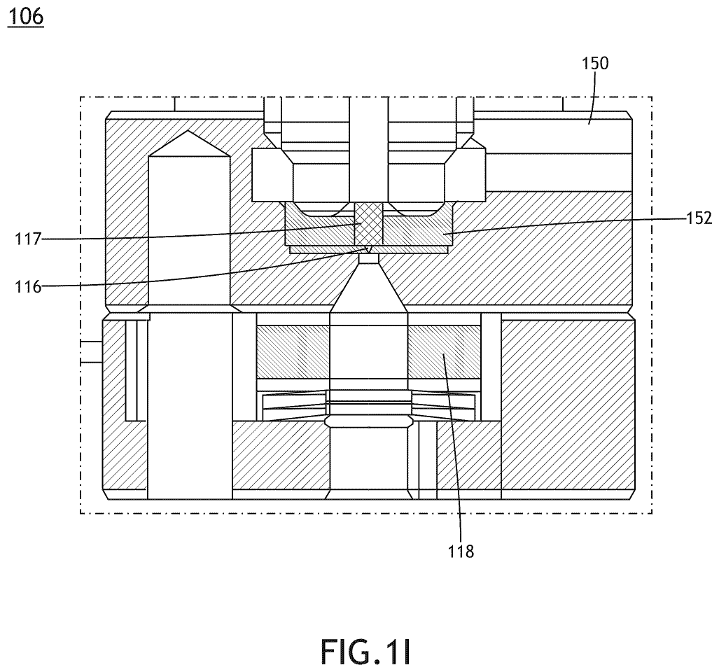

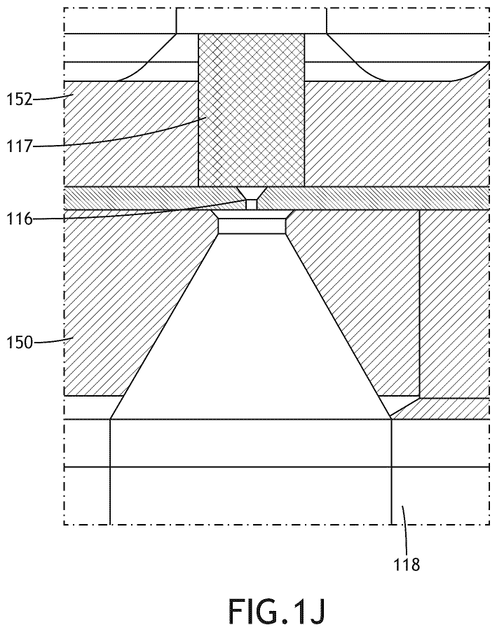

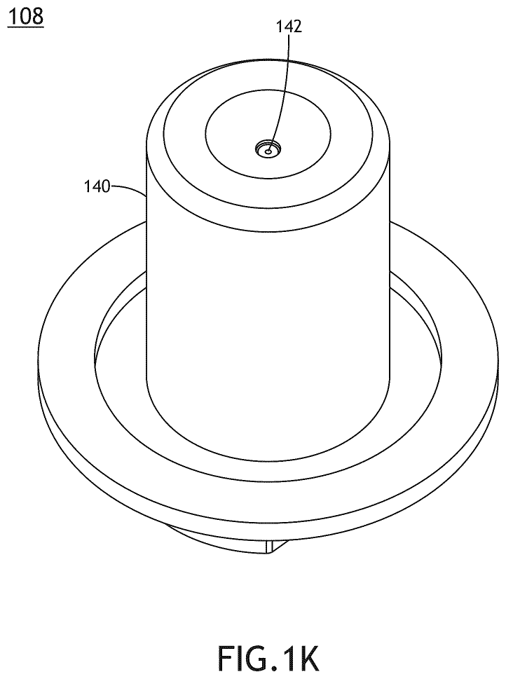

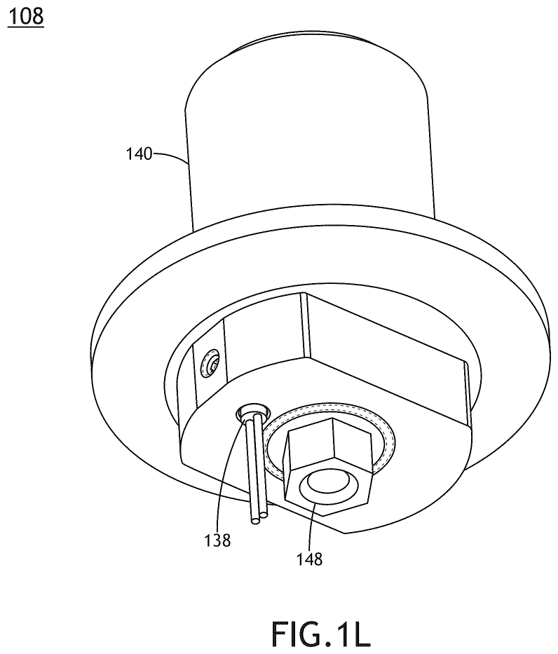

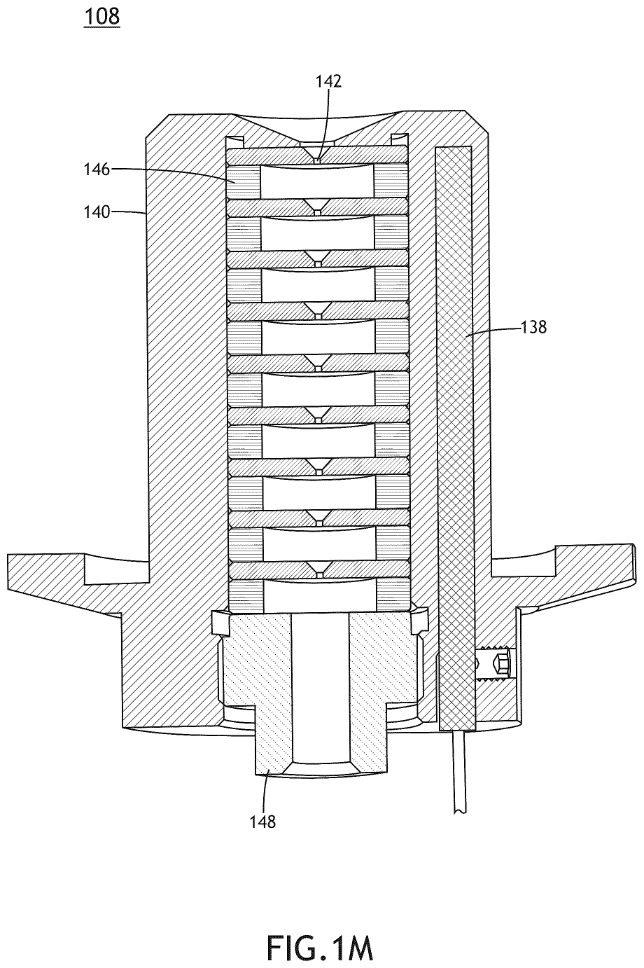

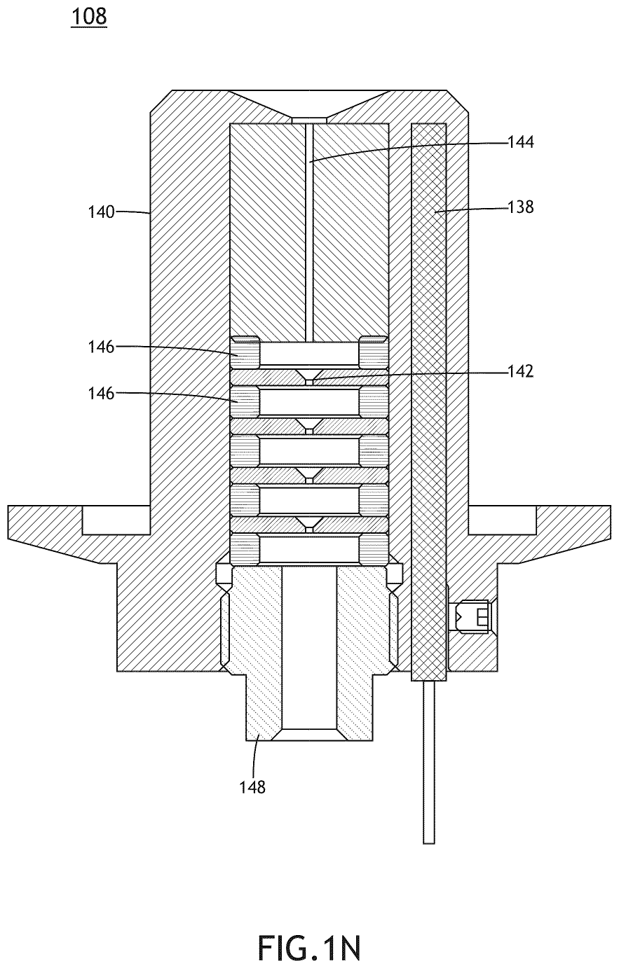

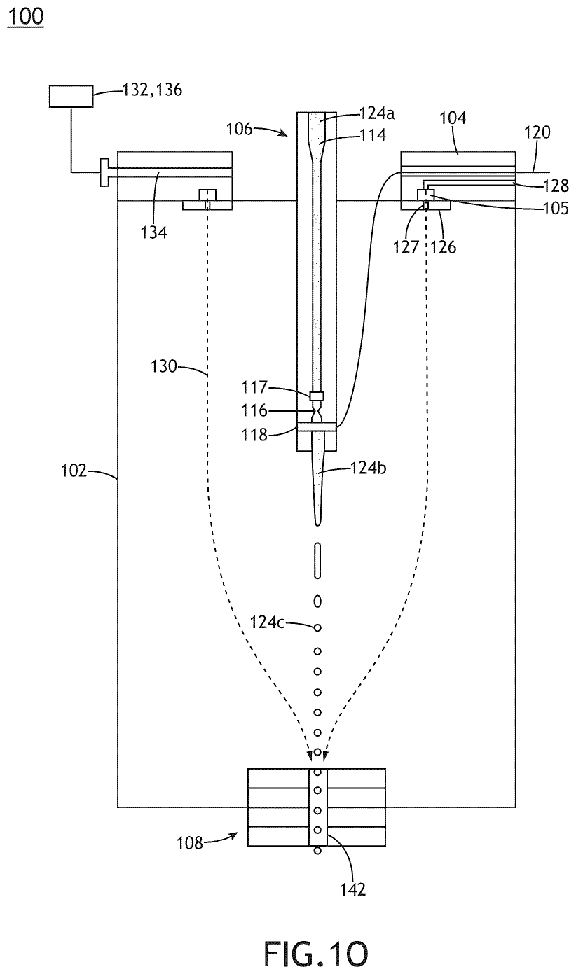

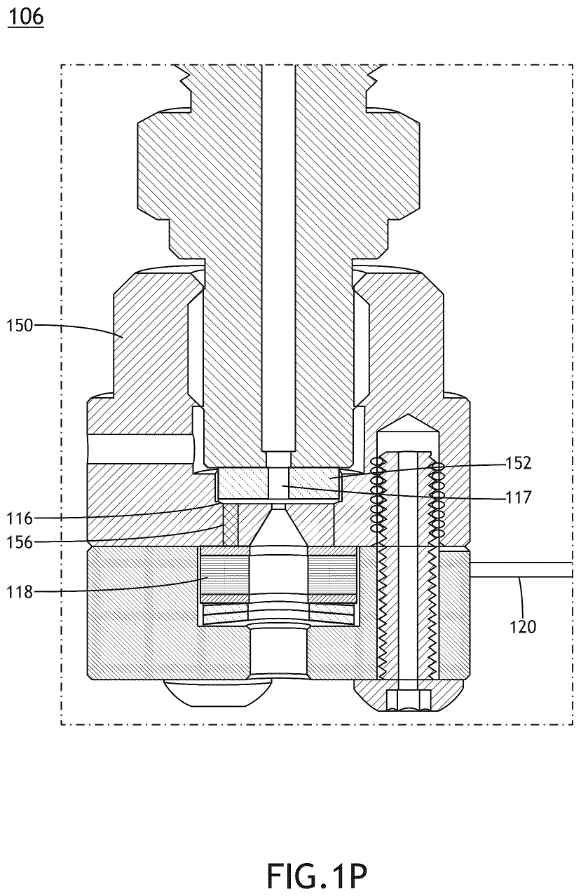

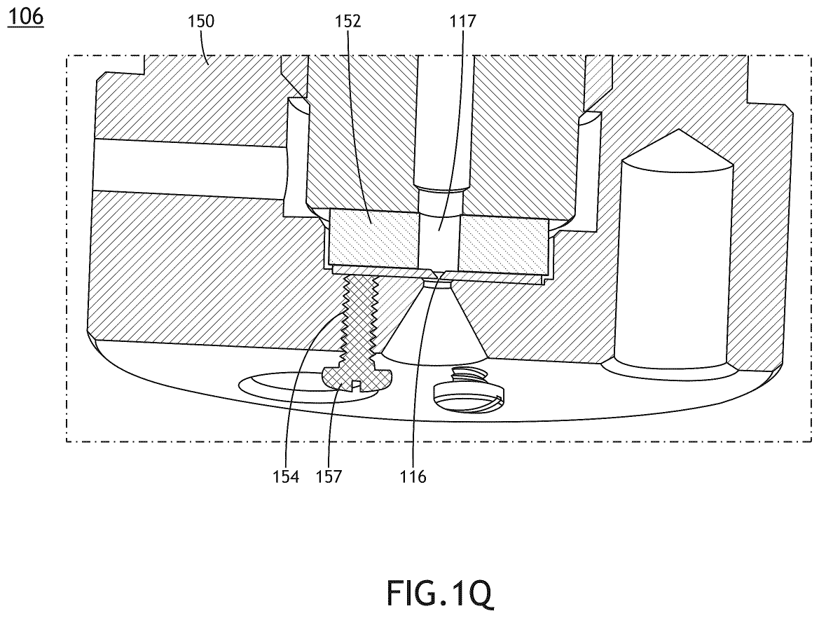

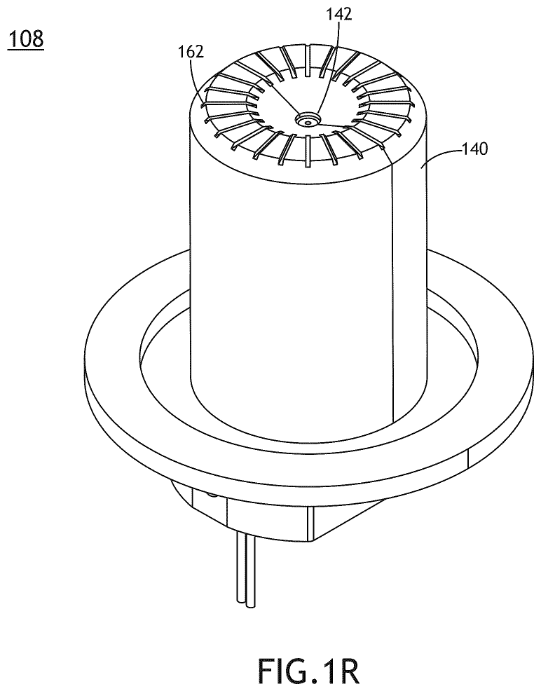

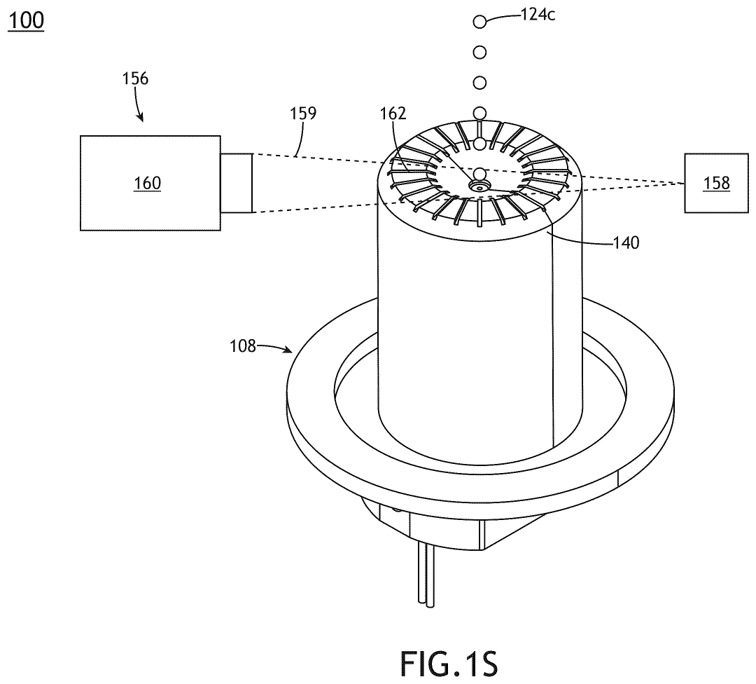

FIGS. 1A-1S illustrate a droplet generator 100, in accordance with one or more embodiments of the present disclosure. The droplet generator 100 may include one or more components. For example, the droplet generator 100 may include an intermediate chamber 102, a support ring 104, an annular chamber 105, a nozzle 106, a skimmer 108, a chamber-to-ring clamp 110, a chamber-to-skimmer clamp 112, a nozzle inlet 114, a nozzle orifice 116, a nozzle filter 117, a piezo-vibrator 118, a transmission line 120, an electrical interface 122, a target material 124, target-material flow 124a, a target-material jet 124b, target-material droplets 124c, a gas-distribution ring 126, a gas interface 128, an ambient gas 130, a pressure sensor 132, a pressure-sensor interface 134, a thermocouple 136, a heater element 138, a skimmer body 140, skimmer apertures 142, skimmer capillaries 144, skimmer spacers 146, a skimmer retaining nut 148, a nozzle body 150, a deformable disk 152, orifice-removal holes 154, a through-beam sensor 156, a strobe 158, a camera 160, diametrical notches 162, or the like.

The intermediate chamber 102 may also be referred to as a triple-point chamber, an intermediate transition chamber, a cryogenic chamber, or the like. The intermediate chamber 102 may be maintained at a select temperature and/or pressure. The temperature and/or pressure of the inside of the intermediate chamber 102 may be maintained at or around a triple-point of the target material 124. The intermediate chamber 102 may include a select ultimate inside pressure. The ambient gas 130 may pressurize the intermediate chamber 102 with an ultimate inside pressure of between 0.5 bar(g) and 2 bar(g). For example, the inside of the intermediate chamber 102 may be rated to an ultimate inside pressure of 1 bar(g). For instance, the inside of the intermediate chamber 102 may be rated to an ultimate inside pressure of 2 bar(g). The intermediate chamber 102 may remain sealed at the ultimate inside pressure. The temperature inside of the intermediate chamber 102 may be cryogenic.

The intermediate chamber 102 may house one or more components of the droplet generator 100. For example, the intermediate chamber 102 may house the nozzle 106, the skimmer 108, the nozzle orifice 116, the nozzle filter 117, the piezo-vibrator 118, the transmission line 120, the target material 124, the target-material flow 124a, the target-material jet 124b, the target-material droplets 124c, the ambient gas 130, the pressure sensor 132, the thermocouple 136, the heater element 138, the skimmer body 140, the skimmer apertures 142, the skimmer capillaries 144, the skimmer spacers 146, and the like. The support ring 104, the chamber-to-ring clamp 110, the chamber-to-skimmer clamp 112, the nozzle inlet 114, the gas-distribution ring 126, the gas interface 128, the pressure-sensor interface 134, and/or the skimmer retaining nut 148 may be disposed outside of the intermediate chamber 102.

The target material 124 may also be referred to as a source material, a plasma-producing material, or the like. The target material 124 may include any plasma-producing target material which may produce a plasma (e.g., plasma 209) when irradiated, and more particularly producing high-temperature plasma which may emit the illumination at a desired wavelength. The target material 124 may be a noble gas. For example, the target material 124 may include xenon (Xe) or krypton (Kr). In embodiments, the target material 124 is xenon.

The nozzle 106 may include one or more components, such as, but not limited to, the nozzle inlet 114, the nozzle orifice 116, the nozzle filter 117, the piezo-vibrator 118, the nozzle body 150, the deformable disk 152, or the like. The nozzle 106 may also include one or more fittings and/or springs coupling between the nozzle inlet 114, the nozzle orifice 116, the nozzle filter 117, the piezo-vibrator 118, the nozzle body 150, and/or the deformable disk 152.

The nozzle 106 may receive the target material 124 as the target-material flow 124a. The nozzle 106 may receive the target-material flow 124a from a condenser (e.g., condenser 208). The target-material flow 124a may be a pressurized liquid phase of the target material 124. For example, the target-material flow 124a may be a pressurized xenon liquid. The nozzle inlet 114 may receive the target-material flow 124a. The nozzle inlet 114 may be any suitable fitting for receiving the target-material flow 124a, such as, but not limited to, a swage lock fitting. The target-material flow 124a may flow through the nozzle 106 from the nozzle inlet 114 to the nozzle orifice 116.

The nozzle 106 may include the nozzle filter 117. The nozzle filter 117 may be axially between the nozzle inlet 114 and the nozzle orifice 116. For example, the nozzle filter 117 may be disposed adjacent to the nozzle orifice 116. The target-material flow 124a may be configured to flow through the nozzle filter 117. The nozzle filter 117 may filter the target-material flow 124a as the target-material flow 124a flows through the nozzle filter 117. The nozzle filter 117 may include any suitable type of filter. For example, the nozzle filter 117 may be a filter frit.

The nozzle 106 may include the nozzle orifice 116. The nozzle orifice 116 may include a select diameter. For example, the nozzle orifice 116 may be diameter of the nozzle orifice 116 may be on the order of tens of nanometers. For instance, the diameter of the nozzle orifice 116 may be between 10 and 99 nm. The nozzle orifice 116 may also include a select precision. For example, the precision of the nozzle orifice 116 may be 1μm or below. The nozzle orifice 116 may control the flow rate of the target-material flow 124a by restricting the target-material flow 124a. The nozzle 106 may eject the target material 124 as the target-material jet 124b. For example, the nozzle orifice 116 may eject the target material 124 as the target-material jet 124b. The target-material jet 124b may be ejected from the nozzle 106 into the intermediate chamber 102.

The nozzle 106 may include the nozzle body 150 and/or the deformable disk 152. The nozzle body 150 may house one or more components of the nozzle 106. For example, the nozzle body 150 may house the nozzle orifice 116, the nozzle filter 117, and/or the deformable disk 152. The nozzle orifice 116 may abut axially between the nozzle body 150 and the deformable disk 152. The deformable disk 152 may be deformed radially outward into abutment with the nozzle body 150. For example, the deformable disk 152 may be deformed radially outward into abutment with the nozzle body 150 by the nozzle filter 117 being pressed into the deformable disk 152. The deformable disk 152 may be deformed (e.g., elastically or plastically) to the shape of the nozzle body 150. The deformable disk 152 may affix the nozzle orifice 116 and the nozzle filter 117 to the nozzle body 150 by being deformed to the shape of the nozzle body 150. Once the deformable disk 152 is deformed to the shape of the nozzle body 150, the nozzle orifice 116, the nozzle filter 117, and/or the deformable disk 152 may be difficult to remove from the nozzle body 150. The nozzle body 150 may define the orifice-removal holes 154 to improve the ease of removing the nozzle orifice 116, the nozzle filter 117, and/or the deformable disk 152 from the nozzle body 150. The orifice-removal holes 154 may be any suitable hole, such as, but not limited to, a threaded-through hole. The orifice-removal holes 154 may be defined axially between the nozzle orifice 116 and the piezo-vibrator 118. The orifice-removal holes 154 may be configured to receive a screw 157 to push out the nozzle orifice 116, the nozzle filter 117, and/or the deformable disk 152 from the nozzle body 150. For example, the orifice-removal holes 154 may be configured to receive the screw 157 when the piezo-vibrator 118 is detached from the nozzle body 150. The screw 157 may or may not be attached to the nozzle body 150 when the piezo-vibrator 118 is attached to the nozzle body 150.

The target-material jet 124b may coalesce into a chain of the target-material droplets 124c. The chain of the target-material droplets 124c may also be referred to as a stream of the target-material droplets 124c, a droplets chain, or the like. The target-material jet 124b may coalesce into the chain of the target-material droplets 124c due to Rayleigh instability. The chain of the target-material droplets 124c may be continuously generated as the target-material jet 124b is ejected from the nozzle 106. The chain of the target-material droplets 124c may be generated with a select frequency. The target-material droplets 124c may include any suitable phase. For example, the target-material droplets 124c may be a liquid, a solid, a supercritical fluid (e.g., supercritical gas), or the like. The target-material droplets 124c may be the liquid when coalescing into the target-material droplets 124c. The target-material droplets 124c may remain as the liquid within the intermediate chamber 102 due to the temperature and/or pressure of the ambient gas 130 within the intermediate chamber 102.

The nozzle 106 may include the piezo-vibrator 118. The piezo-vibrator 118 may be disposed adjacent to the nozzle orifice 116. The piezo-vibrator 118 may be disposed after the nozzle orifice 116 along the path of the target material 124. For example, the nozzle orifice 116 may be disposed between the nozzle filter 117 and the piezo-vibrator 118. In this regard, the piezo-vibrator 118 may be cantilevered at an end of the nozzle 106. The piezo-vibrator 118 may be configured to vibrate the nozzle orifice 116 thereby exciting the target material 124 passing through the nozzle orifice 116 and being ejected as the target-material jet 124b. The vibration introduced by the piezo-vibrator 118 may be a main mode of vibration of the nozzle orifice 116. The excitation provided by the piezo-vibrator 118 may also be referred to as a seed excitation. The excitation of the target material 124 may control the generation of the target-material droplets 124c. For example, the frequency of the piezo-vibrator 118 may control the separation distance of chain of the target-material droplets 124c, the frequency at which the target-material droplets 124c are generated, a size of the target-material droplets 124c, or the like.

The droplet generator 100 may include the transmission line 120. The transmission line 120 may be coupled to and control the piezo-vibrator 118. The transmission line 120 may carry a radio frequency signal (not depicted) to the piezo-vibrator 118 for controlling the piezo-vibrator 118. The radio frequency signal may be modulated to control the generation of the target-material droplets 124c. The transmission line 120 may include any suitable transmission line, such as, but not limited to, a coaxial cable, a twisted pair, a twin-lead, or the like. In embodiments, the transmission line 120 is the coaxial cable. For example, the transmission line may be a shielded coaxial cable. The shielded coaxial cable may be beneficial to reduce a noise associated with the radio frequency signal. The transmission line 120 may be routed to the piezo-vibrator 118 within the intermediate chamber 102. The transmission line 120 may be compatible with the pressure of the intermediate chamber 102.

The droplet generator 100 may include the support ring 104. The support ring 104 may mechanically support one or more components of the droplet generator 100. For example, the support ring 104 may mechanically support the intermediate chamber 102, the chamber-to-ring clamp 110, the electrical interface 122, the gas-distribution ring 126, the gas interface 128, the pressure sensor 132, the pressure-sensor interface 134, the thermocouple 136, or the like. The support ring 104 may or may not mechanically support the nozzle 106. For example, the nozzle 106 may be separated from and unsupported by the support ring 104. For instance, the nozzle 106 may be mechanically supported by a condenser (e.g., condenser 208). The nozzle 106 may be configured to translate and/or rotate relative to the support ring 104. The support ring 104 may define the annular chamber 105.

The droplet generator 100 may include the electrical interface 122. The electrical interface 122 may be arranged radially through the support ring 104. The electrical interface 122 may seal to the intermediate chamber 102. The electrical interface 122 may be for the transmission line 120. The transmission line 120 may pass radially through the support ring 104 via the electrical interface 122 and axially into the intermediate chamber 102. Routing the transmission line 120 through the support ring 104 may be advantageous to reduce the length of the transmission line 120 and/or prevent having to route the transmission line 120 through a condenser chamber upstream of the support ring 104 and/or the nozzle 106. The electrical interface 122 may seal the intermediate chamber 102 and may maintain the pressure of the ambient gas 130 within the intermediate chamber 102.

The nozzle 106 and the skimmer 108 may be disposed at opposing axial ends of the intermediate chamber 102. The length of the intermediate chamber 102 may control the distance between the nozzle 106 and the skimmer 108. The chain of the target-material droplets 124c may pass to the skimmer 108 within the intermediate chamber 102. If the intermediate chamber 102 is too long, the chain of the target-material droplets 124c may diverge. If the intermediate chamber 102 is too short, the target-material droplets 124c may not coalesce from the target-material jet 124b. The length of the intermediate chamber 102 may be on the order of hundreds of millimeters or thousands of millimeters.

The droplet generator 100 may include the gas interface 128. The gas interface 128 may be arranged radially through the support ring 104. The ambient gas 130 may be pumped radially through the support ring 104 via the gas interface 128 and into the intermediate chamber 102. The gas interface 128 may control the pressure of the ambient gas 130 within the intermediate chamber 102.

The droplet generator 100 may include the gas-distribution ring 126. The gas-distribution ring 126 may be coupled to the support ring 104. The annular chamber 105 and/or the gas-distribution ring 126 may receive the ambient gas 130 from the gas interface 128. The gas interface 128 may pump the ambient gas 130 to the annular chamber 105. The ambient gas 130 may pressurize within the annular chamber 105 around the top of the gas-distribution ring 126. The ambient gas 130 axially flow from the annular chamber 105 through the gas-distribution ring 126 into the intermediate chamber 102.

The gas-distribution ring 126 may be an annular ring. The gas-distribution ring 126 may define the through holes 127. The through holes 127 may be arranged in a polar array about a center axis of the gas-distribution ring 126. The ambient gas 130 may flow through the gas-distribution ring 126 via the through holes 127.

The intermediate chamber 102 may be pressurized with the ambient gas 130. Pressurizing the intermediate chamber 102 with the ambient gas 130 may be beneficial to maintain the intermediate chamber 102 at or around the triple point of the target material 124. The ambient gas 130 may flow within the intermediate chamber 102 from the gas-distribution ring 126 to the skimmer 108. The flow of the ambient gas 130 may be disposed axially along and radially outwards of the target-material droplets 124c. The flow of the ambient gas 130 along the target-material droplets 124c may maintain the stability, regularity, and alignment of the chain of the target-material droplets 124c. For example, the flow of the ambient gas 130 may prevent the target-material droplets 124c from moving radially outwards as the target-material droplets 124c move axially from the nozzle 106 to the skimmer 108.

The gas-distribution ring 126 may produce a laminar flow of the ambient gas 130 along the intermediate chamber 102. For example, the flow of the ambient gas 130 from each of the through holes 127 may flow laminarly with minimal lateral mixing. Maintaining the laminar flow of the ambient gas 130 within the intermediate chamber 102 may be beneficial to maintain the stability, regularity, and alignment in the chain of the target-material droplets 124c. The gas-distribution ring 126 with the through holes 127 may be beneficial to improve the uniformity of the flow of the ambient gas 130 within the intermediate chamber 102, as compared to pressurizing the intermediate chamber 102 directly from the gas interface 128. The laminar flow of the ambient gas 130 may be beneficial to maintain the stability of the chain of target-material droplets 124c.

The ambient gas 130 may be a mix of gasses. For example, the ambient gas 130 may include a mix of the target material 124 and one or more additional gases. For instance, the ambient gas 130 may include a mix of xenon and one of argon, hydrogen, or helium. In embodiments, the ambient gas 130 includes a mix of xenon and argon.

The droplet generator 100 may include the skimmer 108. The skimmer 108 may also be referred to as a vacuum interface, a vacuum lock, or the like. The skimmer 108 may fluidically couple between the intermediate chamber 102 and a vacuum pressure (e.g., a vacuum pressure inside a vacuum chamber 204). For example, the area below the skimmer 108 may be the vacuum pressure which is lower than the pressure within the intermediate chamber 102. The target-material droplets 124c and/or the ambient gas 130 may pass through the skimmer 108 from the intermediate chamber 102 to the vacuum pressure. The skimmer 108 may transition the target-material droplets 124c and/or the ambient gas 130 between the pressure within the intermediate chamber 102 and the vacuum pressure. For example, the skimmer 108 may transition the target-material droplets 124c from a relatively high-pressure environment into the vacuum pressure while introducing a minimum disturbance to the target-material droplets 124c.

The skimmer 108 may include one or more components. For example, the skimmer 108 may include the skimmer body 140, the skimmer apertures 142, the skimmer capillaries 144, the skimmer spacers 146, the skimmer retaining nut 148, and the like.

The skimmer body 140 may house the skimmer apertures 142, the skimmer capillaries 144, the skimmer spacers 146, and/or the skimmer retaining nut 148. For example, the skimmer apertures 142, the skimmer capillaries 144, the skimmer spacers 146, and/or the skimmer retaining nut 148 may be housed within a through hole defined by the skimmer body 140. The skimmer apertures 142, the skimmer capillaries 144, the skimmer spacers 146, and/or the skimmer retaining nut 148 may be sealed to the skimmer body 140.

The skimmer apertures 142 and/or the skimmer capillaries 144 may be radially aligned with each other. The target-material droplets 124c may be aligned with and pass through the skimmer apertures 142 and/or the skimmer capillaries 144. For example, the target-material droplets 124c may pass from the intermediate chamber 102 through the skimmer 108 via the skimmer apertures 142 and/or the skimmer capillaries 144. The skimmer 108 may include any number of the skimmer apertures 142 and/or the skimmer capillaries 144. For example, the skimmer 108 may include at least three of the skimmer apertures 142. The skimmer apertures 142 and/or the skimmer capillaries 144 may be formed via any suitable process, such as, but not limited to, drilling, electrical discharge machining, focused ion beam milling, or the like.

The skimmer apertures 142 and/or the skimmer capillaries 144 may be configured to skim off the ambient gas 130 into the space between the skimmer apertures 142, the skimmer capillaries 144, and/or the skimmer spacers 146 as the ambient gas 130 flows through the skimmer apertures 142 and/or the skimmer capillaries 144. The pressure of the ambient gas 130 may be increasingly rarefied (e.g., decreasing in pressure) as the ambient gas 130 flows through the skimmer apertures 142 and/or the skimmer capillaries 144 due to the skimmer apertures 142 and/or the skimmer capillaries 144 skimming off the ambient gas 130. The pressure of the ambient gas 130 may decrease in stages from the intermediate chamber 102 to the vacuum pressure. In this regard, the skimmer 108 may be a multi-stage skimmer. The gas conductance of the ambient gas 130 may be inversely related to the differential pressure between each of the chambers defined between the skimmer apertures 142 and/or the skimmer capillaries 144. It is desirable to maintain as much of the ambient gas 130 within the intermediate chamber 102 as possible, thereby reducing the flow requirement of the ambient gas 130 into the intermediate chamber 102 and reducing the attenuation of the illumination (e.g., illumination 211) downstream of the droplet generator 100 by the ambient gas 130. Multiple of the skimmer apertures 142 and/or the skimmer capillaries 144 being sequentially aligned may allow to reduce the overall gas conductance of the skimmer 108 while keeping the diameters fixed or increase the diameter of such multi-aperture skimmer device while preserving the gas conductance.

The skimmer apertures 142 and/or the skimmer capillaries 144 may include a select length and/or diameter. The skimmer apertures 142 may be considered apertures based on a lower aspect ratio of the diameter and the length while the skimmer capillaries 144 may be considered capillaries based on a higher aspect ratio of the length to the diameter. The aperture ratio of the skimmer capillaries 144 are higher than the aperture ratio of the skimmer apertures 142. The length and/or diameter of the skimmer apertures 142 may or may not be the same for each of the skimmer apertures 142. The skimmer 108 may include various permutations of the number, lengths, and/or diameters of the skimmer apertures 142 and/or the skimmer capillaries 144.

The skimmer apertures 142 may include any suitable geometry. For example, the skimmer apertures 142 may include a countersunk-through hole. The chain of the target-material droplets 124c may pass through the countersunk-through hole. The through hole of the countersunk-through hole may skim the ambient gas 130 from the chain of the target-material droplets 124c. The through hole of the countersunk-through hole may include a select length. For example, the through hole of the countersunk-through hole a length of between 0.1 mm and 1 mm (e.g., 0.5 mm). The countersink of the countersunk-through hole may be wider and longer than the through hole of the countersunk-through hole. The skimming action of the skimmer apertures 142 may be primarily performed by the through hole and not by the countersink of the countersunk-through hole.

The skimmer capillaries 144 may include any suitable geometry. For example, the skimmer capillaries 144 may be a through hole. The length of the skimmer capillaries 144 may be on the order of single-digit millimeters, tens of millimeters, or hundreds of millimeters. For example, the length of the skimmer capillaries 144 may be between 5 mm and 200 mm. For instance, the length of the skimmer capillaries 144 may be between 5 mm and 30 mm. By way of another instance, the length of the skimmer capillaries 144 may be between 30 mm and 200 mm. In embodiments, the length of the skimmer capillaries 144 may be between 5 mm and 10 mm. The shorter lengths of the skimmer capillaries 144 may be desirable due to imposing less stringent requirements to manufacturing precision and nozzle alignment precision.

The diameter of the skimmer apertures 142 (e.g., the diameter of the through hole of the countersunk-through hole defining the skimmer apertures 142) and/or the skimmer capillaries 144 may be on the order of hundreds of micrometers. For example, the diameter of the skimmer apertures 142 may be between 200μm and 800μm. For instance, the diameter may be between 200μm and 500μm. The diameter of the skimmer apertures 142 and/or the skimmer capillaries 144 may be larger than the diameter of the target-material droplets 124c. The diameter of the skimmer apertures 142 and/or the skimmer capillaries 144 may also be orders of magnitude larger than the diameter of the nozzle orifice 116. For example, the diameter of the skimmer apertures 142 and/or the skimmer capillaries 144 may at least three orders of magnitude larger than the diameter of the nozzle orifice 116.

The conductance of the ambient gas 130 across the skimmer apertures 142 and/or the skimmer capillaries 144 may be self-consistent. For example, the conductance of the ambient gas 130 through each of the skimmer apertures 142 and/or the skimmer capillaries 144 may be the same. Having multiple of the skimmer apertures 142 and/or the skimmer capillaries 144 may reduce the conductance of the ambient gas 130 through the skimmer 108. The reduction in the conductance of the ambient gas 130 may reduce the disturbance of the target-material droplets 124c passing through the skimmer 108. Experimental results of the skimmer apertures 142 and the skimmer capillaries 144 indicate that the gas conductance inversed of the ambient gas 130 through the skimmer 108 is based on the number of the skimmer apertures 142 and the skimmer capillaries 144. Gas conductance inversed of the ambient gas 130 through the skimmer 108 may scale with the number (N) of the skimmer apertures 142 as N\hat{ }0.4 for xenon, argon, or any other mixture of monoatomic gas, as compared to a single aperture of the same diameter. The power exponent “0.4” may be a function of the adiabatic index of the gas species used. The gas conductance inversed of the skimmer capillaries 144 was approximately 3 times that of the skimmer apertures 142 of the same diameter. The skimmer capillaries 144 exhibit significant reduction of the gas conductance as well, which appears to be weakly dependent on the capillary length within a wide range of lengths.

The pressure of the ambient gas 130 may be stepped down from the pressure inside the intermediate chamber 102 to the vacuum pressure. The change in pressure of the ambient gas 130 across the skimmer 108 may be based on the number of the skimmer apertures 142 and/or the skimmer capillaries 144, the diameter of the skimmer apertures 142 and/or the skimmer capillaries 144, and/or the length of the skimmer apertures 142 and/or the skimmer capillaries 144. The pressure of the ambient gas 130 may drop from several hundred torr to below 1 torr across the skimmer 108. For example, the pressure may drop from about 600 torr to below 1 torr (e.g., drop to on the order of single digit or tens of millitorr). The pressure drop across each of the skimmer apertures 142 and/or the skimmer capillaries 144 may also be smaller than a single-stage skimmer.

The ambient gas 130 may be a choked flow through the skimmer apertures 142 and/or the skimmer capillaries 144. The speed of the ambient gas 130 may be supersonic due to the choked flow. The choked flow may cause the skimmer apertures 142 and/or the skimmer capillaries 144 to skim off the ambient gas 130.

The Reynolds number of the ambient gas 130 may be a transitional flow or a laminar flow through the skimmer apertures 142 and/or the skimmer capillaries 144. The transition or laminar flow of the ambient gas 130 through the skimmer 108 may stabilize the chain of the target-material droplets 124c. In embodiments, the ambient gas 130 may have the laminar flow through the skimmer apertures 142 and/or the skimmer capillaries 144. The multi-stage skimmer may enable achieving the laminar flow.

The skimmer apertures 142, the skimmer capillaries 144, and/or the skimmer spacers 146 may be axially stacked together. For example, the skimmer apertures 142 and/or the skimmer capillaries 144 may be stacked in sequence with the skimmer spacers 146 disposed therebetween. In this regard, the skimmer spacers 146 may axially space apart the skimmer apertures 142 and/or the skimmer capillaries 144. The skimmer 108 may include any number of the skimmer apertures 142, the skimmer capillaries 144, and/or the skimmer spacers 146. The length of the skimmer spacers 146 may be selected to control the spacing between adjacent of the skimmer apertures 142. The length of the skimmer spacers 146 may or may not be the same along the length of the skimmer 108. For example, the length of the skimmer spacers 146 may the same along the length of the skimmer 108, such that the skimmer apertures 142 and/or the skimmer capillaries 144 are evenly spaced. By way of another example, the length of the skimmer spacers 146 may increase progressively in length away from the nozzle 106 such that the skimmer apertures 142 and/or the skimmer capillaries 144 are spaced progressively further apart from adjacent of the skimmer apertures 142 and/or the skimmer capillaries 144 further from the nozzle 106. The skimmer 108 may be configured to adjust the number of the skimmer apertures 142 and/or the skimmer capillaries 144 and/or the length between the skimmer apertures 142 and/or the skimmer capillaries 144. For example, the skimmer 108 may adjust the number of the skimmer apertures 142 and/or the skimmer capillaries 144 and/or the length between the skimmer apertures 142 and/or the skimmer capillaries 144 by replacing the skimmer spacers 146 with different lengths of the skimmer spacers 146. The skimmer body 140 may receive various numbers of the skimmer apertures 142, the skimmer capillaries 144, and/or the skimmer spacers 146 in any suitable combination and permutation.

The skimmer 108 may be a passive skimmer. For example, the pressure of the skimmer 108 between the skimmer apertures 142, the skimmer capillaries 144, and/or the skimmer spacers 146 may be passively set by the pressure of the intermediate chamber 102. It is further contemplated that the skimmer 108 may be an active skimmer. For example, the skimmer 108 may include gas feedthroughs (not depicted) disposed axially between the skimmer apertures 142, the skimmer capillaries 144, and/or the skimmer spacers 146. The gas feedthroughs may actively control the pressure inside each stage of the skimmer 108.

The skimmer 108 may include the skimmer retaining nut 148. The skimmer retaining nut 148 may be affixed to the skimmer body 140. The skimmer retaining nut 148 may clamp together the skimmer apertures 142, the skimmer capillaries 144, and/or skimmer spacers 146 within the skimmer body 140. The skimmer retaining nut 148 may define a through hole through which the chain of the target-material droplets 124c and/or the ambient gas 130 may pass through to the vacuum pressure.

The intermediate chamber 102 may be optically transparent. For example, the intermediate chamber 102 may be a quartz tube. For example, the intermediate chamber 102 may be optically transparent to ultraviolet light, visible light, and/or infrared light. The skimmer 108 may be visible through the intermediate chamber 102. For example, a first of the skimmer apertures 142 and/or the skimmer capillaries 144 of the skimmer 108 may be visible through the intermediate chamber 102. The intermediate chamber 102 may be optically transparent for enabling visual alignment of the chain of the target-material droplets 124c with the skimmer 108 (e.g., with the skimmer apertures 142 and/or the skimmer capillaries 144). Ensuring the alignment of the target-material droplets 124c with the skimmer 108 may be beneficial to prevent the target-material droplets 124c from freezing to the skimmer apertures 142, thereby blocking the chain of the target-material droplets 124c from passing through the skimmer 108.

The skimmer body 140 may define the diametrical notches 162. The diametrical notches 162 may be defined diametrically through the skimmer body 140. The diametrical notches 162 may be used for visually aligning the chain of the target-material droplets 124c with the skimmer apertures 142 and/or the skimmer capillaries 144 of the skimmer 108. For example, the diametrical notches 162 may provide a line-of-sight radially through the skimmer body 140 to a first of the skimmer apertures 142 and/or the skimmer capillaries 144 of the skimmer 108. The skimmer body 140 may define any number of the diametrical notches 162. For example, the diametrical notches 162 may be defined in a polar array about a center axis of the skimmer body 140, with an equal spacing between adjacent of the diametrical notches 162. For instance, the diametrical notches 162 may include a 15-degree spacing azimuthally between adjacent of the diametrical notches 162, although this is not intended to be limiting. The skimmer body 140 may define multiple of the diametrical notches 162 to allow flexibility of rotation of the skimmer 108 during installation and optical alignment.

The droplet generator 100 may include the through-beam sensor 156. The through-beam sensor 156 may be disposed outside of the intermediate chamber 102. The through-beam sensor 156 may detect the alignment of the chain of target-material droplets 124c relative to the skimmer 108. For example, the through-beam sensor 156 may detect the alignment of the chain of target-material droplets 124c relative to the first of the skimmer apertures 142 and/or the skimmer capillaries 144 of the skimmer 108. The through-beam sensor 156 may detect the alignment of the chain of target-material droplets 124c relative to the skimmer 108 through the intermediate chamber 102 (e.g., by the intermediate chamber 102 being optically transparent) and/or through the skimmer body 140 (e.g., radially through the diametrical notches 162). The through-beam sensor 156 may include the strobe 158 and the camera 160. The strobe 158 and the camera 160 may be axially aligned. The strobe 158 and the camera 160 may also be axially aligned with a first of the skimmer apertures 142 and/or the skimmer capillaries 144 of the skimmer 108. The strobe 158 may generate a strobe illumination 159. The strobe illumination 159 may pass radially through the diametrical notches 162 to the camera 160. The target-material droplets 124c may interrupt the strobe illumination 159 when the target-material droplets 124c are aligned with the skimmer 108 and the strobe illumination 159. The camera 160 may capture images of the target-material droplets 124c and the skimmer 108 based on the strobe illumination 159. The images may indicate the alignment of the chain of the target-material droplets 124c with the skimmer 108.

The skimmer 108 may include the heater element 138. The heater element 138 may be disposed within the skimmer body 140. The heater element 138 may be radially offset from and axially aligned with the skimmer apertures 142 and/or the skimmer capillaries 144. The heater element 138 may include any suitable heater element. For example, the heater element 138 may be an inductive heating element, a cartridge heater element, a band heater element, a coil heater element, or the like. The heater element 138 may be configured for a select power. For example, the heater element 138 may be configured for between 5 W and 10 W, although this is not intended to be limiting. The heater element 138 may be configured to heat the skimmer 108. For example, the heater element 138 may be configured to heat the skimmer apertures 142 and/or the skimmer capillaries 144. The heater element 138 heating the skimmer 108 may melt the target material 124 which has frozen to the skimmer 108. For example, the heater element 138 may be configured to melt the target material 124 which has frozen to the skimmer apertures 142 and/or the skimmer capillaries 144. In case of a misalignment of the chain of the target-material droplets 124c with the skimmer apertures 142 and/or the skimmer capillaries 144, the target-material droplets 124c may freeze to the skimmer apertures 142 and/or the skimmer capillaries 144. The heater element 138 may allow melting the target material 124 in case of the misalignment of the chain of the target-material droplets 124c with the skimmer apertures 142 and/or the skimmer capillaries 144. Melting the target material 124 may save time to recover the droplet generator 100 back to the operational state in the event of misalignment followed by xenon ice build-up and clogging of the skimmer apertures 142 and/or the skimmer capillaries 144. Disposing the heater element 138 within the skimmer body 140 and axially aligning the heater element 138 with each of the skimmer apertures 142 and/or the skimmer capillaries 144 may be beneficial to reduce the axial length of the skimmer 108, the skimmer apertures 142, and/or the skimmer capillaries 144 (e.g., as compared to a heater element disposed within a body of the skimmer apertures 142 and/or the skimmer capillaries 144).

The droplet generator 100 may include the chamber-to-ring clamp 110 and/or the chamber-to-skimmer clamp 112. The chamber-to-ring clamp 110 and the chamber-to-skimmer clamp 112 may clamp together the intermediate chamber 102 with respective of the support ring 104 and the skimmer 108. The chamber-to-ring clamp 110 and the chamber-to-skimmer clamp 112 may be configured to detach the intermediate chamber 102 from respective of the support ring 104 and the skimmer 108. The ability to detach the intermediate chamber 102 from respective of the support ring 104 and the skimmer 108 may improve the ease of and reduces the time of maintenance, of making modifications, of relacing the intermediate chamber 102, of replacing the nozzle 106, of replacing the skimmer 108, and the like. For example, the droplet generator 100 may be configured to swap between different lengths of the intermediate chamber 102 using the chamber-to-ring clamp 110 and the chamber-to-skimmer clamp 112. By way of another example, the chamber-to-skimmer clamp 112 may enable changing the skimmer 108 while the intermediate chamber 102 and the support ring 104 are clamped by the chamber-to-ring clamp 110.

The chamber-to-ring clamp 110 and the chamber-to-skimmer clamp 112 may include any suitable clamping interface. For example, the clamping interface may include a KF-40 interface, a quick clamp, a vacuum clamp, a bulkhead-style quick clamp, a clamshell-style quick clamp, or the like. For example, the chamber-to-ring clamp 110 may be the bulkhead-style quick clamp. By way of another example, the chamber-to-skimmer clamp 112 may be the clamshell-style quick clamp. The intermediate chamber 102 may be braised or epoxied to a flange of the chamber-to-ring clamp 110 and the chamber-to-skimmer clamp 112 to enabling the coupling by the chamber-to-ring clamp 110 and the chamber-to-skimmer clamp 112.

The droplet generator 100 may include the pressure sensor 132. The pressure sensor 132 may be configured to measure the pressure of the intermediate chamber 102. The pressure sensor 132 may be an absolute pressure sensor or a gauge pressure sensor. In embodiments, the pressure sensor 132 may be the absolute pressure sensor. For example, the absolute pressure sensor may measure the pressure of the intermediate chamber 102 relative to the vacuum pressure.

The droplet generator 100 may include the pressure-sensor interface 134. The pressure-sensor interface 134 may be arranged radially through the support ring 104. The pressure-sensor interface 134 may extend radially through to the nozzle 106. The pressure-sensor interface 134 may be disposed axially between the nozzle inlet 114 and the nozzle orifice 116. The annular chamber 105 may be disposed axially between the pressure-sensor interface 134 and the gas-distribution ring 126. In this regard, the pressure-sensor interface 134 may be upstream of the flow of the ambient gas 130 and/or the target-material droplets 124c. The pressure-sensor interface 134 may be for the pressure sensor 132. The pressure sensor 132 may pass radially through the support ring 104 via the pressure-sensor interface 134 into the intermediate chamber 102. Routing the pressure sensor 132 through the support ring 104 may be advantageous to enable sensing an absolute pressure using the pressure sensor 132.

The droplet generator 100 may include the thermocouple 136. The thermocouple 136 may be configured to measure the temperature of the intermediate chamber 102. For example, the thermocouple 136 may receive a flow of the ambient gas 130 from the intermediate chamber 102 and measure the temperature of the ambient gas 130. The thermocouple 136 may receive the flow of the ambient gas 130 from the intermediate chamber 102 via the pressure-sensor interface 134.

The droplet generator 100 may be configured to feedback control the flow of the ambient gas 130 flowing through the gas interface 128 into the intermediate chamber 102 and/or the temperature of the intermediate chamber 102 based on the pressure measurement from the pressure sensor 132 and/or the temperature measurement from the thermocouple 136. For example, the droplet generator 100 may feedback control the pressure and/or temperature inside the intermediate chamber 102, causing the chain of the target-material droplets 124c to remain in liquid phase within the intermediate chamber 102 due to the pressure and/or temperature.

The droplet generator 100 may provide a select stability for the chain of the target-material droplets 124c flowing through the intermediate chamber 102 and the skimmer 108. For example, the distortion of the trajectory to the chain of the target-material droplets 124c along the intermediate chamber 102 and the skimmer 108 may be smaller than 10% of the diameter of the target-material droplets 124c. The droplet generator 100 may achieve the stability by the laminar flow of the ambient gas 130 and/or due to smaller flowrate and lower gas velocities of the ambient gas 130 by the multiple stages of the skimmer apertures 142 and/or skimmer capillaries 144. The multiple stages of the skimmer 108 may improve spatial alignment, regularity, and temporal stability of the chain of the target-material droplets 124c upon transitioning from the intermediate chamber 102 with higher pressure into the vacuum pressure.

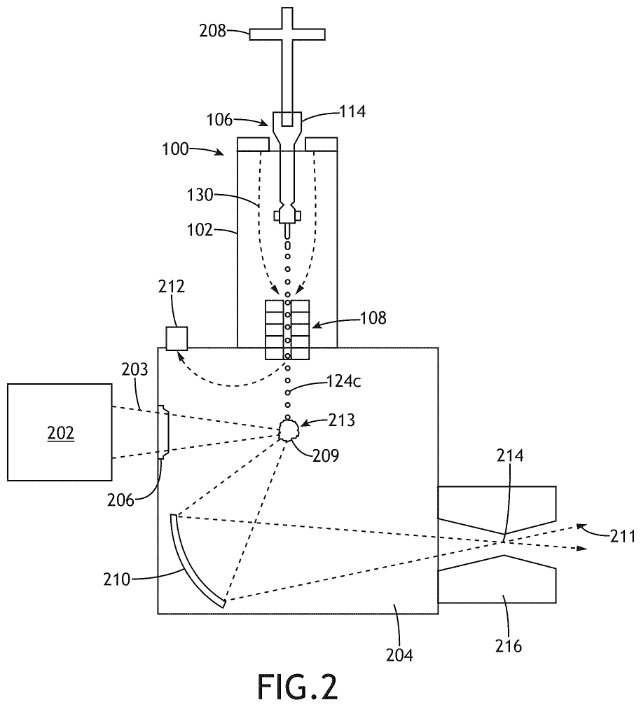

FIG. 2 illustrates an illumination source 200 in accordance with one or more embodiments of the present disclosure. The illumination source 200 may include the droplet generator 100. The illumination source 200 may also include one or more components, such as, but not limited to, a laser source 202, a laser 203, a vacuum chamber 204, refractive optics 206, a condenser 208, a plasma 209, a collector 210, illumination 211, vacuum pumps 212, a plasma site 213, an intermediate focal point 214, an internal focus module 216, or the like.

The illumination source 200 may include the laser source 202. The laser source 202 may be a pulsed-laser source, a modulated-laser source, or the like. For example, the laser source 202 may be the pulsed-laser source. The laser source 202 may be any suitable laser source, such as a solid-state laser. The laser source 202 may include any suitable gain medium, such as, but not limited to, a fiber-shaped, rod-shaped, or disk-shaped active media. The laser source 202 may include, but is not limited to, Nd:YAG, Er:YAG, Yb:YAG, Ti:Sapphire, Nd:Vanadate, a gas-discharge laser, an excimer laser, a MOPA configured excimer laser, an excimer laser having one or more chambers, a master oscillator/power oscillator (MOPO) arrangement, a master oscillator/power ring amplifier (MOPRA) arrangement, a power oscillator/power amplifier (POPA) arrangement, a solid state laser that seeds one or more excimer or molecular fluorine amplifier or oscillator chambers, a pulsed-gas discharge CO2 laser, or the like.

The laser source 202 may be configured to generate the laser 203. The laser 203 may also be referred to as a drive laser, a plasma-pumping laser, or the like. The laser 203 may be a pulsed laser. For example, the laser 203 may be a pulsed infrared (IR) laser. The laser 203 may include a select power and/or pulse-repetition rate. For example, the laser 203 may include a relatively low power (e.g., from about 10 W to about 1 kW) and/or a relatively low pulse-repetition rate (e.g., between about 2 kHz and 50 kHz). By way of another example, the laser 203 may include a relatively high power (e.g., 10 kW or higher) and/or a relatively high pulse-repetition rate (e.g., above 50 kHz, above 100 kHz, or the like).

The illumination source 200 may include the vacuum chamber 204. The vacuum chamber 204 may be configured to maintain the vacuum pressure within the vacuum chamber 204. The vacuum pressure may refer to any pressure that is lower than atmospheric pressure. The vacuum chamber 204 may be a low-pressure container in which the plasma 209 is produced at the plasma site 213 and the illumination 211 is collected and focused. The illumination 211 may be strongly absorbed by gases, thus, reducing the pressure within the vacuum chamber 204 reduces the attenuation of the illumination 211 within the illumination source 200.

The vacuum chamber 204 may house one or more components of the illumination source 200 within the vacuum chamber 204. For example, the vacuum chamber 204 may house the refractive optics 206, the plasma 209, the collector 210, the plasma site 213, and the like.

The illumination source 200 may include the refractive optics 206. The refractive optics 206 may also be referred to as an entrance window, a vacuum window, an entrance lens, a vacuum lens, or the like. The refractive optics 206 may be a window (e.g., zero optical power), a converging lens (e.g., positive optical power), or the like. The refractive optics 206 may be sealed to the vacuum chamber 204. For example, the refractive optics 206 may be coupled to a sidewall of the vacuum chamber 204 and may maintain the vacuum pressure inside the vacuum chamber 204. In this regard, the refractive optics 206 may include a vacuum interface with the vacuum chamber 204. The laser 203 may be configured to refract through the refractive optics 206 into the vacuum chamber 204. The refractive optics 206 may provide a path for transmitting the laser 203 into the vacuum chamber 204. To maintain the low-pressure environment inside the vacuum chamber 204, the laser 203 may pass into the vacuum chamber 204 through the refractive optics 206. The refractive optics 206 may also focus the laser 203 onto the target-material droplets 124c (e.g., where the refractive optics 206 is the converging lens). The refractive optics 206 may be made of any suitable laser which is configured to refract the laser 203 and which is compatible with the vacuum environment. For example, the refractive optics 206 may made calcium fluoride (CaF2), silicon dioxide (SiO2), or the like.

The illumination source 200 may include the condenser 208. The condenser 208 may condense the target material 124 from a gas to the target-material flow 124a. The condenser 208 may pressurize and/or cool the target material 124, such that the target material 124 condenses into the target-material flow 124a. The condenser 208 may be coupled to and configured to pump the target-material flow 124a to the nozzle 106 of the droplet generator 100. The nozzle inlet 114 of the nozzle 106 may connect to the condenser 208 for receiving the target-material flow 124a.

The illumination source 200 may include the droplet generator 100. The droplet generator 100 may be configured to generate the target-material droplets 124c from the target-material flow 124a, as described previously herein. The droplet generator 100 may supply the target-material droplets 124c into the vacuum chamber 204 via the skimmer 108. The skimmer 108 may supply the target-material droplets 124c into the vacuum chamber 204 away from the plasma site 213. The target-material droplets 124c may travel via free-space within the vacuum chamber 204 to the plasma site 213.

The droplet generator 100 may be affixed to the vacuum chamber 204. The droplet generator 100 may be affixed to the vacuum chamber 204 outside of the vacuum chamber 204 or affixed to the vacuum chamber 204 inside of the vacuum chamber 204. For example, the droplet generator 100 may be affixed to the vacuum chamber 204 outside of the vacuum chamber 204. Affixing the droplet generator 100 to the vacuum chamber 204 outside of the vacuum chamber 204 may be beneficial for providing viewports to view inside the intermediate chamber 102 and/or for ease of disconnecting the droplet generator 100 from the vacuum chamber 204 for servicing the droplet generator 100. Any suitable portion of the droplet generator 100 may be affixed to the vacuum chamber 204. For example, the skimmer 108 may be affixed to the vacuum chamber 204. For instance, the skimmer body 140 may be affixed to the vacuum chamber 204.

The droplet generator 100 deliver the target-material droplets 124c into the path of the laser 203 at the plasma site 213. The target-material droplets 124c may be delivered in such a way that the target-material droplets 124c may intersect with the laser 203 as the laser 203 is focused onto the target-material droplets 124c. For example, the droplet generator 100 may deliver the target-material droplets 124c at the focal point of the laser 203. The target-material droplets 124c may travel to a site in the vacuum chamber 204 where the target-material droplets 124c are irradiated by the laser 203. The target-material droplets 124c may be a small amount of material that will be acted upon by the laser 203 and thereby converted to the plasma 209. The target-material droplets 124c may be within a gas, a liquid, or a solid phase immediately before being irradiated by the laser 203. For example, a portion the target-material droplets 124c may evaporate upon entering the vacuum chamber 204, the evaporation may cool the target-material droplets 124c and cause the target-material droplets 124c to be within the solid phase immediately before being irradiated by the laser 203. In embodiments, the target-material droplets 124c may be droplets of solid xenon, although this is not intended to be limiting.

The stability, regularity, and alignment of the chain of the target-material droplets 124c are critical requirements to enable the target-material droplets 124c to be irradiated by the laser 203. The droplet generator 100 reducing the flowrate of the ambient gas 130 into the vacuum chamber 204 may benefit the illumination source 200 in many ways, including a reduced operation costs, an enhanced conversion efficiency of the illumination source 200, a reduced attenuation of the illumination 211, and the like. The stability of the chain of the target-material droplets 124c may also reduce jitter when irradiating the target-material droplets 124c with the laser 203 and improve overall stability and performance of the illumination source 200. Maintaining a consistent chain of the target-material droplets 124c using the droplet generator 100 may be beneficial to allow the laser 203 to irradiate the target-material droplets 124c and enable producing the plasma 209.

The target-material droplets 124c may be configured to produce the plasma 209. The laser 203 may irradiate the target-material droplets 124c at the plasma site 213 within the vacuum chamber 204. The laser 203 and/or the target-material droplets 124c may be positioned to irradiate the target-material droplets 124c in the path of the laser 203. The laser 203 may be focused on the target-material droplets 124c. For example, the laser 203 may be focused onto the target-material droplets 124c within the vacuum chamber 204. The target-material droplets 124c may be irradiated by the laser 203 at a focal point or spot of the laser 203. The laser 203 may irradiate the target material in one or more pulses. The laser 203 may cause the target-material droplets 124c to produce the plasma 209 at the plasma site 213. The absorption cross-section of the target material 124 and/or the plasma 209 may cause the target-material droplets 124c to absorb the laser 203. For example, the wavelength of the laser 203 may match an absorption line of the target material 124. The target-material droplets 124c may be in any suitable phase immediately before producing the plasma 209. For example, the target-material droplets 124c may be in the phase of a solid, a liquid, or a supercritical fluid (e.g., supercritical gas) immediately before producing the plasma 209. In embodiments, the target-material droplets 124c may be solid xenon (e.g., xenon ice) immediately before producing the plasma 209, although this is not intended to be limiting.

The laser 203 may produce the plasma 209 by initiating and/or maintaining the plasma 209. The illumination source 200 may be a laser-produced plasma (LPP) source or a laser-discharge produced plasma (LDP or laser-initiated DPP) source. The illumination source 200 may or may not include an electrode (not depicted) to assist the laser 203 in producing the plasma 209 from the target-material droplets 124c. For example, the illumination source 200 may be the LPP source which may use the laser 203 to produce the plasma 209 from the target-material droplets 124c without the electrode. The absorption of the laser 203 by the target-material droplets 124c may ionize the target-material droplets 124c, producing the plasma 209. For instance, the laser 203 may irradiate the target-material droplets 124c with a first pulse (pre-pulse) followed by a second pulse (main pulse) to produce the plasma 209. By way of another example, the illumination source 200 may be the LDP source may use the laser 203 in combination with the electrode to produce the plasma 209 from the target-material droplets 124c. The electrodes may be coils surrounding the target-material droplets 124c which may magnetically excite the target-material droplets 124c. For instance, the laser 203 may evaporate the target-material droplets 124c using the laser 203 followed by pinching the evaporation via the electrode to produce the plasma 209. By way of another instance, the electrodes may initiate the plasma 209 followed by the laser 203 maintaining the plasma 209. As depicted, the illumination source 200 may be the LPP source which may use the laser 203 to produce the plasma 209 from the target-material droplets 124c without the electrode, although this is not intended to be limiting.

The plasma 209 may be heated to a select electron temperature. For example, the plasma 209 may be heated by the laser 203 (e.g., by pulses of the laser 203) and/or by the electrode. The electron temperature of the plasma 209 may be selected based on the wavelength of the wavelength of the illumination 211 desired for the application of the illumination source 200. For example, the plasma 209 may be high-temperature plasma. For instance, the electron temperature of the plasma 209 may be between 20 and 40 eV, or the like.

The illumination source 200 may include the illumination 211. The illumination 211 may also be referred to as exposure light. The plasma 209 may emit the illumination 211. For example, the high-temperature plasma may emit the illumination 211. The illumination 211 may be broadband. The plasma 209 may emit the illumination 211 as broadband radiation. The illumination 211 may be generated by the plasma 209 through de-excitation of excited species within the plasma 209. The plasma 209 may include various excited species, including the target material 124. The spectrum of the illumination 211 may be dependent on the composition of species within the plasma 209, energy levels of excited states of species within the plasma 209, the temperature of the plasma 209, and/or the pressure surrounding the plasma 209. In this regard, the spectrum of the illumination 211 generated by the plasma 209 may be tuned to include emission within a desired wavelength range by selecting the composition of the target material 124 to have one or more emission lines within the desired wavelength range. Often, a desired material (e.g. a desired element, a desired species, or the like) suitable for generating emission within a desired wavelength range exists in a liquid or a solid phase such that high temperatures are required to evaporate the target-material droplets 124c and maintain a desired pressure for the plasma 209. In another embodiment, the power, wavelength, and focal characteristics of the illumination source 200 are adjusted to obtain a desired conversion efficiency of absorbed energy to emission output within a desired wavelength range.

The illumination 211 may include a select wavelength. The illumination 211 may be vacuum-ultraviolet (VUV) light and/or soft X-ray light. The illumination source 200 may produce the illumination 211 within the vacuum chamber 204 to prevent the atmosphere from absorbing the VUV light and/or the soft X-ray light. The VUV light may have a wavelength of between 10 nm and 200 nm. The VUV light may be far ultraviolet (FUV) light and/or extreme ultraviolet (EUV) light. The FUV light may have a wavelength of between 121 and 200 nm. The EUV light may have a wavelength of between 10 nm and 124 nm. The soft X-ray light may have a wavelength of between 0.1 and 10 nm. In embodiments, the illumination 211 may be in-band EUV light having a wavelength of 13.5 nm. The in-band EUV light may also be referred to as actinic light (e.g., where the actinic light is used for inspecting a reticle or wafer at the same wavelength used for lithography). For example, the in-band EUV light may have a wavelength of 13.5 nm with 2% bandwidth. Although the illumination 211 is described as the in-band EUV light, this is not intended to be limiting. It is contemplated that the benefits provided by the illumination source 200, may be applicable to any of the VUV light and/or soft X-ray light formed by the plasma 209 operating within the vacuum chamber 204.

The illumination source 200 may include the collector 210. The collector 210 may also be referred to as a collector mirror, collector optics, reflective optics, or the like. The illumination 211 may be transmitted to the collector 210. The collector 210 may collect the illumination 211 and focus the illumination 211 to the intermediate focal point 214. The collector 210 may include two focal points. For example, the focal points of the collector 210 may include the plasma site 213 (e.g., coinciding with the final focal point of the laser 203) and the intermediate focal point 214. The collector 210 may be located off-axis from the path of the laser 203 between the refractive optics 206 and the target-material droplets 124c.

The collector 210 may focus the illumination 211 to the intermediate focal point 214 by reflecting the illumination 211. For example, the collector 210 may be configured to reflect the VUV light and/or the soft X-ray light. For instance, the collector 210 may be configured to reflect the EUV light. In embodiments, the collector 210 may be configured to reflect the in-band EUV light. The collector 210 which is configured to reflect the EUV light (e.g., the in-band EUV light) may be any suitable material. For example, the material which reflects the in-band EUV light may be ruthenium (Ru), molybdenum (Mo) (e.g., Mo/Si multilayer mirrors), niobium (Nb) (e.g., niobium-carbon and silicion (NbC/Si) multilayer mirrors), engineered high density carbon films having high Sp3 content (e.g. tetrahedral (Ta-—C)), or the like. The collector 210 may also be a multi-layer coating. The collector 210 may be a multi-layer mirror. The multi-layer mirror may include a graded multi-layer coating with alternating layers of material. The multi-layer coating may also include high-temperature diffusion barrier layers, smoothing layers, capping layers, etch stop layers, and the like.

The collector 210 may be arranged at a select incidence angle to the illumination 211. For example, the collector 210 may be a near-normal-incidence mirror, a grazing-incidence mirror, or the like. For instance, the collector 210 may be the near-normal-incidence mirror. The collector 210 may be any suitable shape to collect the illumination 211. For example, the collector 210 may be an elliptical collector, a collector with multiple surface contours, a truncated prolate spheroid (i.e., an ellipse rotated about its major axis) or a segment thereof, or the like.

The illumination source 200 may include the internal focus module 216. The internal focus module 216 may collect and refocus the illumination 211. The internal focus module 216 may be coupled to and disposed outside of the vacuum chamber 204. The internal focus module 216 may be a dynamic gas lock to preserve the low-pressure environment within the vacuum chamber 204. The internal focus module 216 may also protect downstream optics that interact with the illumination 211 from the target material 124.

The illumination source 200 may include the intermediate focal point 214 of the illumination 211. The collector 210 may be configured to focus the illumination 211 to the intermediate focal point 214. The intermediate focal point 214 may be inside the internal focus module 216. In this regard, the collector 210 may directs the illumination 211 out of the vacuum chamber 204 and into the internal focus module 216.

The illumination source 200 may include the vacuum pumps 212. The vacuum pumps 212 may be connected to vacuum chamber 204. The vacuum pumps 212 may establish and maintain the low-pressure environment of the vacuum chamber 204. The vacuum pumps 212 may include any suitable pump. For example, the vacuum pumps 212 may be a turbo pump, turbo-molecular pump, and/or a roots pump. The vacuum pumps 212 include a dry pumping unit and/or an exhaust system. The vacuum pumps 212 may remove the target material 124 and/or the ambient gas 130 from the vacuum chamber 204. After the target material 124 produces the plasma 209 at the plasma site 213, the target material 124 and/or the ambient gas 130 may be directed towards the vacuum pumps 212.

The illumination source 200 may be used in any suitable application. The illumination 211 may be collected for use in a semiconductor process. For example, the illumination source 200 may be used within an inspection system 300, a lithography system (not depicted), or the like. The illumination 211 may be the in-band EUV light which may be particularly suitable for use in metrology and/or mask inspection activities (e.g., actinic mask inspection and including blank or patterned mask inspection) using the inspection system 300.

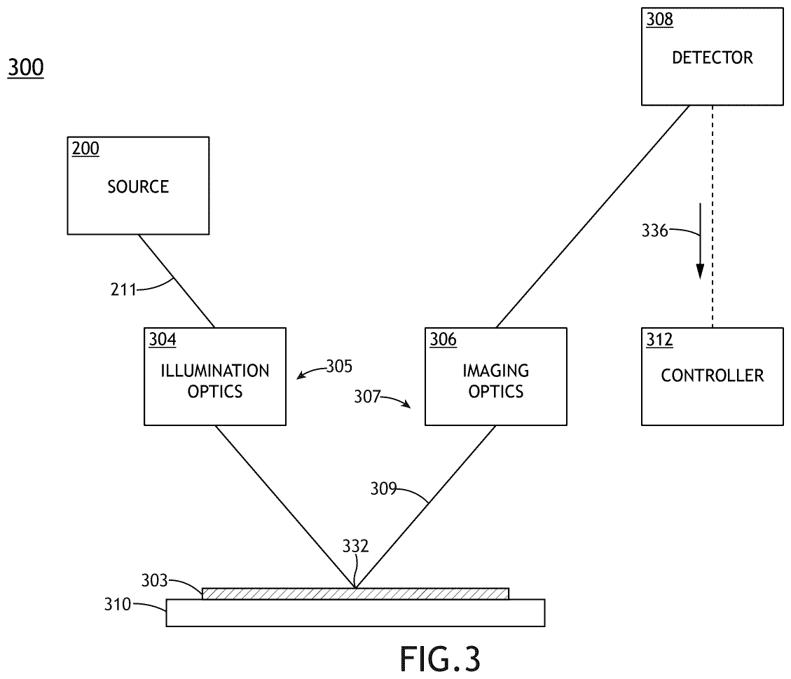

FIG. 3 illustrates an inspection system 300, in accordance with one or more embodiments of the present disclosure. The inspection system 300 may be an EUV reticle inspection tool, an EUV inspection system, a EUV mask projection system, or the like. For example, the inspection system 300 may be an actinic inspection system by using the in-band EUV light that may represent what will be realized using EUV light during lithography. The inspection system 300 may operate in a vacuum to prevent the atmosphere from absorbing the illumination 211 and/or the collected light 309.

The inspection system 300 may include illumination source 200. The inspection system 300 may be configured to inspect the sample 303. The inspection system 300 may be configured to inspect the sample 303 by illuminating the sample 303 with illumination 211, collect collected light 309 from the sample 303, and detecting field images 336 based on the collected light 309. The collected light 309 may include a field plane 332, the field images 336, and the like.

The illumination 211 and/or the collected light 309 may be extreme ultraviolet (EUV) light. The EUV light may have a wavelength of between 10 nm and 121 nm. For example, the EUV light may have a wavelength between 5 nm and 30 nm. For instance, the EUV light may have a wavelength between 5 and 15 nm. In embodiments, the illumination 211 may be in-band EUV light having a wavelength of 13.5 nm. For example, the in-band EUV light may have a wavelength of 13.5 nm with 2% bandwidth. Although the illumination 211 and/or the collected light 309 is described as the in-band EUV light, EUV light at other wavelength ranges may also be used. The illumination 211 and/or the collected light 309 may be continuous, pulsed, modulated, or the like. For example, the illumination 211 and/or the collected light 309 may be pulsed.

The inspection system 300 may direct the illumination 211 to the sample 303. For example, the inspection system 300 may be configured to direct the illumination 211 to the sample 303 along the illumination path 305. The illumination path 305 may be an optical path for providing the illumination 211 to the sample 303 being inspected. The illumination path 305 may include the illumination optics 304 which direct the illumination 211 to the sample 303. The illumination optics 304 may include one or more optical components (not depicted). The illumination optics 304 may include and/or be downstream of the internal focus module 216 in the illumination path 305. The optical components may be optical mirrors (e.g., due to the wavelength of the illumination 211). The illumination optics 304 may reflect the illumination 211 such that the illumination 211 illuminates the sample 303. The illumination optics 304 may include a series of condensing mirrors configured to condense the illumination 211 into a narrow beam directed to the sample 303. The illumination optics 304 may also include a multiplexing mirror to multiplex the illumination 211 from one or more of the illumination source 200. The optical components may also process and/or shape the illumination 211 prior to directing onto the sample 303. For example, the illumination optics 304 may include collector optics, homogenizers, spectral purity filters, relays, condensers, and the like. The collector optics may collect the illumination 211 from the illumination source 200 and direct the illumination 211 to the sample 303. The homogenizer may change the illumination 211 from a gaussian beam to a flat-top beam. The flat-top beam may also be referred to as a top-hat beam. The spectral purity filter may filter wavelengths (e.g., drive laser wavelengths of the illumination source 200) from the illumination 211. The relays may relay the illumination 211 between any of the various optical components of the illumination optics 304. The condenser may condense the illumination 211 into a converging beam on the sample 303. The illumination path 305 may also include an additional aperture stop (not depicted), which may be referred to as an illumination-aperture stop.

The sample 303 may include a mask blank, a photomask, a wafer, a die, or the like. The photomask may also be referred to as a reticle. For example, the sample 303 may be a photomask used in extreme ultraviolet (EUV) lithography.

The stage 310 may support the sample 303. The stage 310 may be an actuatable stage. The illumination 211 and/or the collected light 309 may be scanned in a scanning direction over the sample 303. The stage 310 may scan the illumination 211 and the collected light 309 in a scanning direction over the sample 303. The sample 303 may be scanned under the illumination 211 and/or the collected light 309 by actuating the stage 310. The stage 310 may include any device suitable for positioning and/or scanning the sample 303 within the inspection system 300. For example, the stage 310 may include any combination of linear translation stages, rotational stages, tip/tilt stages, or the like. For example, the stage 310 may include, but is not limited to, one or more translational stages suitable for translating the sample 303 along one or more linear directions (e.g., x-direction, y-direction, and/or z-direction). By way of another example, the stage 310 may include, but is not limited to, one or more rotational stages suitable for rotating the sample 303 along a rotational direction. By way of another example, the stage 310 may include, but is not limited to, a rotational stage and a translational stage suitable for translating the sample 303 along a linear direction and/or rotating the sample 303 along a rotational direction.

The illumination 211 may reflect from the sample 303 as collected light 309. The collected light 309 may reflect via specular reflection, scattering, diffusion, or the like. The illumination path 305 and the imaging path 307 may be spatially separated. The illumination 211 and the collected light 309 may be off-axis when being directed to and reflected from, respectively, the sample 303. The collected light 309 may reflect from the sample 303 off-axis to the illumination 211. The collected light 309 may be patterned light. For example, the collected light 309 may be patterned according to the mask, the wafer, and/or the die of the sample 303. The pattern may also indicate defects associated with the sample 303. The illumination source 200 may also illuminate the sample 303 via critical illumination. The collected light 309 may be the EUV light (e.g., the in-band EUV light).

The imaging path 307 may be the optical path for collected light 309 from the sample 303 being inspected to the detector 308. The imaging optics 306 may be configured to direct the collected light 309 from the sample 303 to the detector 308 along the imaging path 307. The imaging path 307 may include the imaging optics 306 which direct the collected light 309 to the detector 308. The imaging optics 306 may be between the field plane 332 and the detector 308.

The imaging optics 306 may output a projection of the collected light 309 onto the detector 308. The imaging optics 306 may collect the collected light 309 and form images at the detector 308. For example, the imaging optics 306 may be configured to image the field images 336 on the detector 308. The field images 336 may be a conjugate of the field plane 332.

The field plane 332 may also be referred to as an object plane, a reticle plane, a mask plane, or the like. The field plane 332 may be the reflection of the illumination 211 on the sample 303. The field plane 332 may be represented by one or more field points. The collected light 309 reflected, diffracted, or scattered from different locations on the sample 303 may be detected in different locations in the field plane 332, regardless of the collection angle.

The field images 336 may be conjugates to the field plane 332. For example, the collected light 309 emanating from a particular point of the field plane 332 at any angle may be imaged to a corresponding to a particular point in the field images 336. The field images 336 may be a final conjugate plane of the field plane 332.

The detector 308 may be configured to detect the field images 336 from the collected light 309. The detector 308 may be a time-delay-integration detector array.

The detector 308 may be configured to provide the field images 336 to the controller 312. The controller 312 may receive the field images 336 from the detector 308. The controller 312 may use the field images 336 to detect one or more defects on the sample 303, or the like.

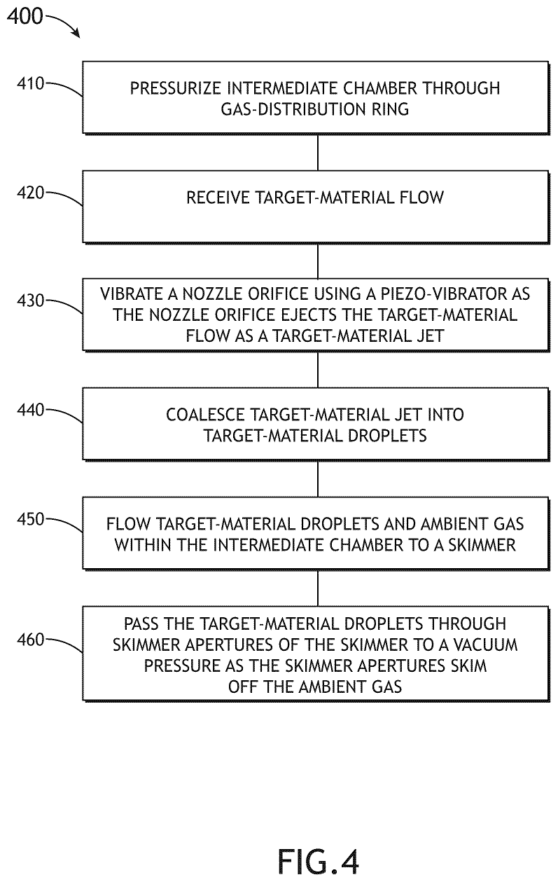

FIG. 4 illustrates a flow diagram of a method 400, in accordance with one or more embodiments of the present disclosure. The method 400 may be a method of generating the target-material droplets 124c using the droplet generator 100. The embodiments and the enabling technologies described previously herein in the context of the droplet generator 100, the illumination source 200, and the inspection system 300 should be interpreted to extend to the method. It is further noted, however, that the method is not limited to the architecture of the droplet generator 100, the illumination source 200, and the inspection system 300.

In a step 410, a gas interface may pressurize an intermediate chamber with an ambient gas by flowing the ambient gas through a gas-distribution ring. For example, the gas interface 128 may pressurize the intermediate chamber 102 with the ambient gas 130 by flowing the ambient gas 130 through the gas-distribution ring 126.

In a step 420, a nozzle inlet may receive a target-material flow. For example, the nozzle inlet 114 may receive the target-material flow 124a.

In a step 430, a piezo-vibrator may vibrate a nozzle orifice as the nozzle orifice ejects the target-material flow as a target-material jet into the intermediate chamber. For example, the piezo-vibrator 118 may vibrate the nozzle orifice 116 as the nozzle orifice 116 ejects the target-material flow 124a as the target-material jet 124b into the intermediate chamber 102.

In a step 440, the target-material jet may coalesce as a chain of target-material droplets. For example, the target-material jet 124b may coalesce as the chain of the target-material droplets 124c.

In a step 450, the target-material droplets and the ambient gas may flow within the intermediate chamber to a skimmer. For example, the target-material droplets 124c and the ambient gas 130 may flow within the intermediate chamber 102 to the skimmer 108.

In a step 460, the target-material droplets may pass through the skimmer apertures of the skimmer to a vacuum pressure as the skimmer apertures skim off the ambient gas. For example, the target-material droplets 124c may pass through the skimmer apertures 142 of the skimmer 108 to a vacuum pressure as the skimmer apertures 142 skim off the ambient gas 130. The target-material droplets 124c may also pass through the skimmer capillaries 144 of the skimmer 108 to the vacuum pressure as the skimmer capillaries 144 skim off the ambient gas 130.

Referring generally again to the figures. The droplet generator 100 may include a stage (not depicted). The stage may be an X-Y stage with tip/tilt, or the like. The stage may control the position and/or orientation of the nozzle 106 to align the target-material droplets 124c with the skimmer 108 based on the images captured by the camera 160. The process of aligning the chain of the target-material droplets 124c using the stage may be automated or manual. For example, a user may view the images and manually align the chain of the target-material droplets 124c with the skimmer apertures 142 based on the images. By way of another example, a controller may receive the images and automatically align the chain of the target-material droplets 124c with the skimmer apertures 142 based on the images.

A controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

A controller may include one or more processors and/or memory. The memory may maintain program instructions which may be executable by the processors, causing the controller to perform any of the various functions of the controller.

The one or more processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program. Moreover, different subsystems of the system may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers.

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive, and the like. The memory medium may include flash memory cells, or other type memory, discrete EPROM or EEPROM, or the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet, and the like).

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A droplet generator comprising:
an intermediate chamber;
a nozzle, wherein the nozzle comprises a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets;
a transmission line, wherein the transmission line is coupled to and configured to control the piezo-vibrator;
a support ring, wherein the support ring mechanically supports the intermediate chamber;
a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and
a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer.

2. The droplet generator of claim 1, wherein the target material comprises xenon, wherein the ambient gas comprises a mix of xenon and at least one of argon, hydrogen, or helium.

3. The droplet generator of claim 1, wherein the nozzle comprises a nozzle filter, wherein the nozzle filter is disposed axially between the nozzle inlet and the nozzle orifice.

4. The droplet generator of claim 3, wherein the nozzle comprises a nozzle body and a deformable disk, wherein the nozzle body houses the nozzle orifice, the nozzle filter, and the deformable disk, wherein the nozzle orifice abuts axially between the nozzle body and the deformable disk, wherein the deformable disk is deformed radially outward into abutment with the nozzle body by the nozzle filter, wherein the nozzle body defines an orifice-removal hole, wherein the orifice-removal hole is defined axially between the nozzle orifice and the piezo-vibrator.

5. The droplet generator of claim 1, wherein the transmission line comprises a coaxial cable.

6. The droplet generator of claim 1, comprising an electrical interface, wherein the electrical interface is arranged radially through the support ring, wherein the transmission line passes radially through the support ring via the electrical interface and axially into the intermediate chamber.

7. The droplet generator of claim 1, wherein the nozzle is configured to translate and rotate relative to the support ring.

8. The droplet generator of claim 1, comprising a gas-distribution ring, wherein the gas-distribution ring is coupled to the support ring, wherein the support ring defines an annular chamber, wherein the gas interface is configured to pump the ambient gas to the annular chamber, wherein the ambient gas is configured to axially flow from the annular chamber through the gas-distribution ring into the intermediate chamber.

9. The droplet generator of claim 8, wherein the gas-distribution ring defines a plurality of through holes, wherein the plurality of through holes are arranged in a polar array, wherein the ambient gas is configured to flow through the gas-distribution ring via the plurality of through holes.

10. The droplet generator of claim 8, wherein the gas-distribution ring is configured to produce a laminar flow of the ambient gas along the intermediate chamber.

11. The droplet generator of claim 1, wherein the skimmer comprises a skimmer body, a plurality of skimmer apertures, and a plurality of skimmer spacers, wherein the skimmer body houses the plurality of skimmer apertures and the plurality of skimmer spacers, wherein the target-material droplets are aligned with and configured to pass through the plurality of skimmer apertures to the vacuum pressure, wherein the plurality of skimmer apertures are configured to skim off the ambient gas as the ambient gas flows through the plurality of skimmer apertures, wherein the plurality of skimmer apertures and the plurality of skimmer spacers are stacked axially.

12. The droplet generator of claim 11, wherein the plurality of skimmer apertures are countersunk-through holes, wherein a through hole of the countersunk-through holes comprises a length of between 0.1 mm and 1 mm.

13. The droplet generator of claim 11, wherein the skimmer comprises at least one skimmer capillary, wherein an aperture ratio of the at least one skimmer capillary is higher than aperture ratios of the plurality of skimmer apertures, wherein the target-material droplets are aligned with and configured to pass through the plurality of skimmer apertures and the at least one skimmer capillary to the vacuum pressure, wherein the plurality of skimmer apertures and the at least one skimmer capillary are configured to skim off the ambient gas as the ambient gas flows through the plurality of skimmer apertures and the at least one skimmer capillary, wherein the plurality of skimmer apertures, the at least one skimmer capillary, and the plurality of skimmer spacers are stacked axially.

14. The droplet generator of claim 13, wherein a length of the at least one skimmer capillary is between 5 mm and 200 mm.

15. The droplet generator of claim 11, wherein the ambient gas has a laminar flow through the plurality of skimmer apertures.

16. The droplet generator of claim 11, wherein the skimmer comprises a skimmer retaining nut, wherein the plurality of skimmer apertures and the plurality of skimmer spacers are clamped together within the skimmer body by the skimmer retaining nut.

17. The droplet generator of claim 11, wherein the skimmer comprises a heater element, wherein the heater element is disposed within the skimmer body, wherein the skimmer body is radially offset from and axially aligned with the plurality of skimmer apertures, wherein the heater element is configured to heat the plurality of skimmer apertures.

18. The droplet generator of claim 11, wherein the intermediate chamber is optically transparent, wherein the skimmer is visible through the intermediate chamber.

19. The droplet generator of claim 18, comprising a through-beam sensor, wherein the skimmer body defines a diametrical notch, wherein the through-beam sensor is configured to detect an alignment of the chain of target-material droplets relative to the skimmer through the intermediate chamber and through the diametrical notch.

20. The droplet generator of claim 1, comprising a chamber-to-ring clamp and a chamber-to-skimmer clamp, wherein the chamber-to-ring clamp clamps together the intermediate chamber and the support ring, wherein the chamber-to-ring clamp clamps together the intermediate chamber and the skimmer.

21. The droplet generator of claim 1, comprising a pressure-sensor interface, wherein the pressure-sensor interface is arranged radially through the support ring.

22. An illumination source comprising:
a droplet generator comprising:
an intermediate chamber;
a nozzle, wherein the nozzle comprises a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets;
a transmission line, wherein the transmission line is coupled to and configured to control the piezo-vibrator;
a support ring, wherein the support ring mechanically supports the intermediate chamber;
a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and
a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer;
a vacuum chamber, wherein the droplet generator is configured to supply the chain of target-material droplets into the vacuum chamber via the skimmer; and
a laser source, wherein the laser source is configured to generate a laser, wherein the laser is configured to irradiate the target material at a plasma site within the vacuum chamber, wherein the laser causes the target-material droplets to produce a plasma, wherein the plasma is configured to emit illumination.

23. The illumination source of claim 22, wherein the droplet generator is affixed to the vacuum chamber outside of the vacuum chamber.

24. The illumination source of claim 22, comprising a condenser, wherein the nozzle is mechanically supported by the condenser, wherein the nozzle inlet is configured to receive the target-material flow from the condenser.

25. An inspection system comprising:
an illumination source comprising:
a droplet generator comprising:
an intermediate chamber;
a nozzle, wherein the nozzle comprises a nozzle inlet, a nozzle orifice, and a piezo-vibrator, wherein the nozzle inlet is configured to receive a target material as a target-material flow, wherein the target-material flow is configured to flow through the nozzle from the nozzle inlet to the nozzle orifice, wherein the piezo-vibrator is configured to vibrate the nozzle orifice and excite the target material passing through the nozzle orifice, wherein the nozzle orifice is configured to eject the target material as a target-material jet into the intermediate chamber, wherein the target-material jet is configured to coalesce into a chain of target-material droplets;
a transmission line, wherein the transmission line is coupled to and configured to control the piezo-vibrator;
a support ring, wherein the support ring mechanically supports the intermediate chamber;
a skimmer, wherein the nozzle and the skimmer are disposed at opposing axial ends of the intermediate chamber, wherein the chain of the target-material droplets are configured to pass to the skimmer within the intermediate chamber, wherein the skimmer fluidically couples between the intermediate chamber and a vacuum pressure; and
a gas interface, wherein the gas interface is arranged radially through the support ring, wherein an ambient gas is configured to be pumped radially through the support ring via the gas interface and into the intermediate chamber, wherein the ambient gas is configured to pressurize the intermediate chamber, wherein the ambient gas is configured to flow within the intermediate chamber to the skimmer;
a vacuum chamber, wherein the droplet generator is configured to supply the chain of target-material droplets into the vacuum chamber via the skimmer; and
a laser source, wherein the laser source is configured to generate a laser, wherein the laser is configured to irradiate the target material at a plasma site within the vacuum chamber, wherein the laser causes the target-material droplets to produce a plasma, wherein the plasma is configured to emit illumination.
